(19) United States
(12) Patent Application Publication
(10) Pub. No.: US 2023/0038334 A1
(43) Pub. Date: Feb. 9, 2023

(54) SYSTEM TO PREDICT FAILURES AND DUTY LIFE CYCLE IN INDUSTRIAL SHOCK ABSORBERS BASED ON PRESSURE AND TEMPERATURE DATA

(71) Applicant: ACE CONTROLS INC., Farmington Hills, MI (US)

(72) Inventors: Christopher M. Niemiec, Livonia, MI (US); Rahul Chandrashekar, Farmongton, MI (US)

(21) Appl. No.: 17/863,839

(22) Filed: Jul. 13, 2022

Related U.S. Application Data
(60) Provisional application No. 63/230,296, filed on Aug. 6, 2021.

(51) Int. Cl. F16F 9/32; G05B 23/02

(52) U.S. Cl. CPC F16F 9/3292; F16F 9/3264; F16F 9/3221; G05B 23/0283; F16F 2230/0047

(57) ABSTRACT

An industrial shock absorber system may include at least one sensor that is configured to measure an operating parameter of the industrial shock absorber during operation of the shock. The system may be configured to determine Time-Through-Stroke (TTS) and/or Rod Return Time (RRT) utilizing data from the sensor or sensors. The system may be configured to utilize machine learning to detect and/or predict a failure of the industrial shock absorber.

### CROSS-REFERENCE TO RELATED APPLICATION

This application claims the benefit under 35 U.S.C. § 119(e) to U.S. Provisional Patent Application No. 63/230,296, filed Aug. 6, 2021, entitled “SYSTEM TO PREDICT FAILURES AND DUTY LIFE CYCLE IN INDUSTRIAL SHOCK ABSORBERS BASED ON PRESSURE AND TEMPERATURE DATA,” which is incorporated herein by reference in its entirety.

### BACKGROUND OF THE INVENTION

Various energy-absorbing mechanisms (e.g. industrial shock absorbers) for decelerating moving objects have been developed. Industrial shock absorbers may be used in a wide variety of applications.

### BRIEF DESCRIPTION OF THE DRAWINGS

In the drawings:

FIG. 1 is a schematic side elevational view of a system according to one aspect of the present disclosure;

FIG. 1A is a cross sectional view of an industrial shock absorber prior to application of a force to the piston rod;

FIG. 1B is a cross-sectional view of the industrial shock absorber of FIG. 1A showing the piston rod in a retracted position after application of an external force;

FIG. 1C shows the industrial shock absorber of FIG. 1A after the applied force is released;

FIG. 1D shows the industrial shock absorber of FIG. 1A after the piston rod returns to its extended position;

FIG. 1E is a cross-sectional isometric view of an industrial shock absorber including a pressure probe (sensor) that detects pressure inside an inner tube of the industrial shock absorber, a pressure and/or temperature probe (sensor) that detects pressure and/or temperature outside of the inner shock tube, and a vibration sensor;

FIG. 2 is a schematic showing an industrial shock absorber, computing device, and display according to one aspect of the present disclosure;

FIG. 2A is a display according to another aspect of the present disclosure;

FIG. 2B is a partially schematic illustration of a wireless system according to an aspect of the present disclosure;

FIG. 2C is a partially schematic illustration of a wired system according to an aspect of the present disclosure;

FIG. 3 is a flow chart according to an aspect of the present disclosure;

FIG. 3A is a flow chart according to another aspect of the present disclosure;

FIG. 3B is a schematic showing machine learning according to another aspect of the present disclosure;

FIG. 4A is a chart according to an aspect of the present disclosure;

FIG. 4B is a chart according to another aspect of the present disclosure;

FIG. 4C is a chart according to another aspect of the present disclosure;

FIG. 4D is a chart according to another aspect of the present disclosure;

FIG. 5A is a chart according to another aspect of the present disclosure;

FIG. 5B is a chart according to another aspect of the present disclosure;

FIG. 6A is a chart according to another aspect of the present disclosure;

FIG. 6B is a chart according to another aspect of the present disclosure;

FIG. 7A is a chart according to another aspect of the present disclosure;

FIG. 7B is a chart according to another aspect of the present disclosure;

FIG. 8 is a chart according to another aspect of the present disclosure;

FIG. 9 is a graph showing calculation of Time-Through-Stroke (TTS) using a force sensor that may be located in an inner tube of an industrial shock absorber;

FIG. 10 is a graph showing Time-Through-Stroke (TTS) calculation utilizing a measured pressure in an inner tube of an industrial shock absorber; and

FIG. 11 is a graph showing measured force and internal pressure versus stroke showing “good” (non-failure) data patterns.

### DETAILED DESCRIPTION

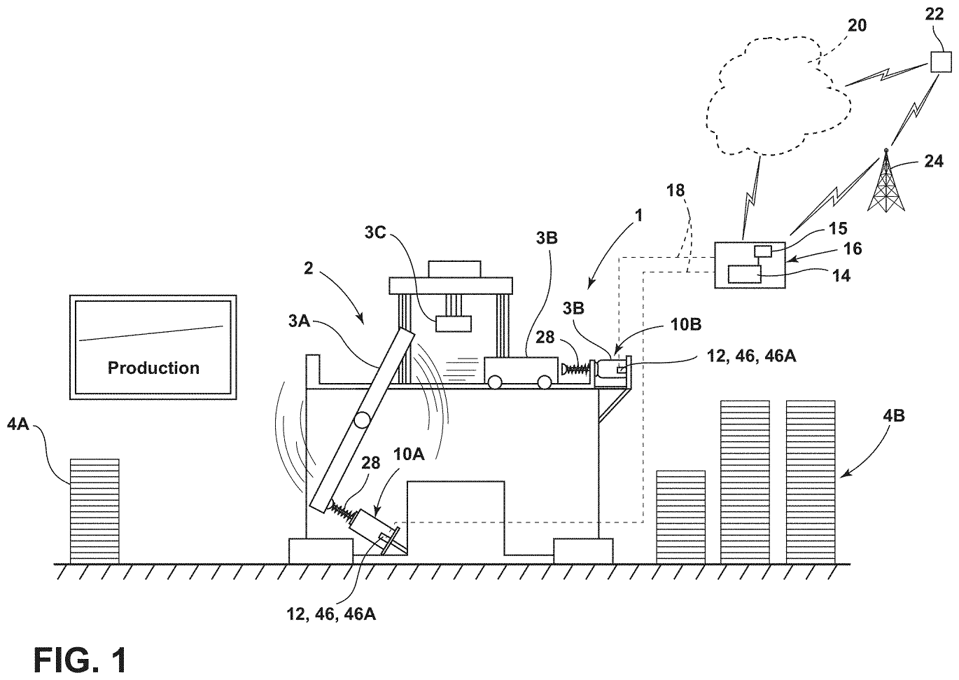

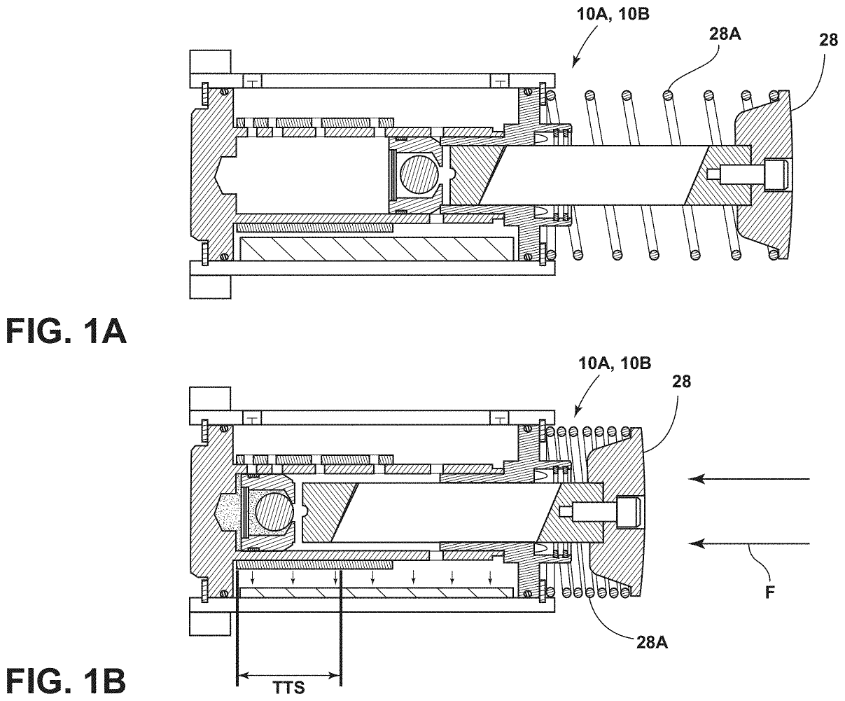

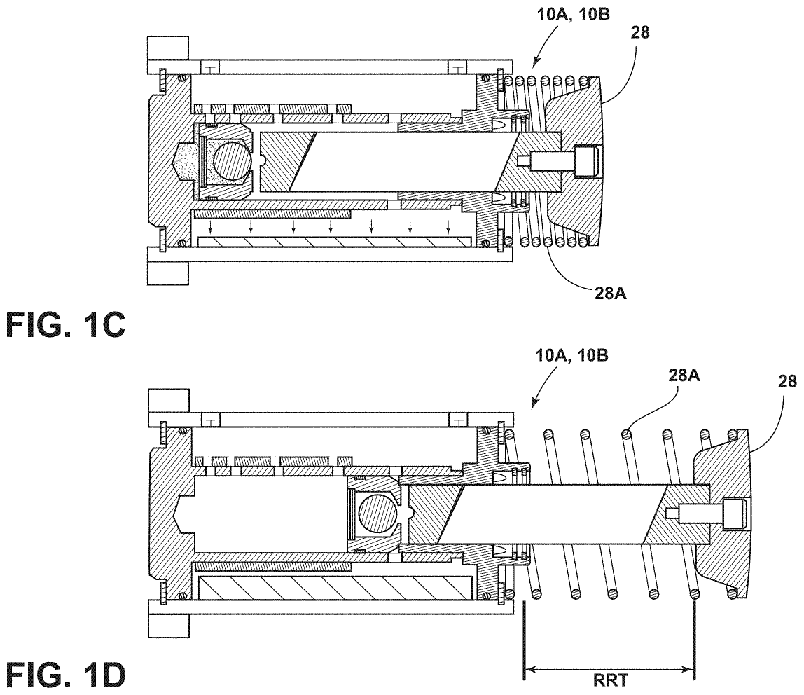

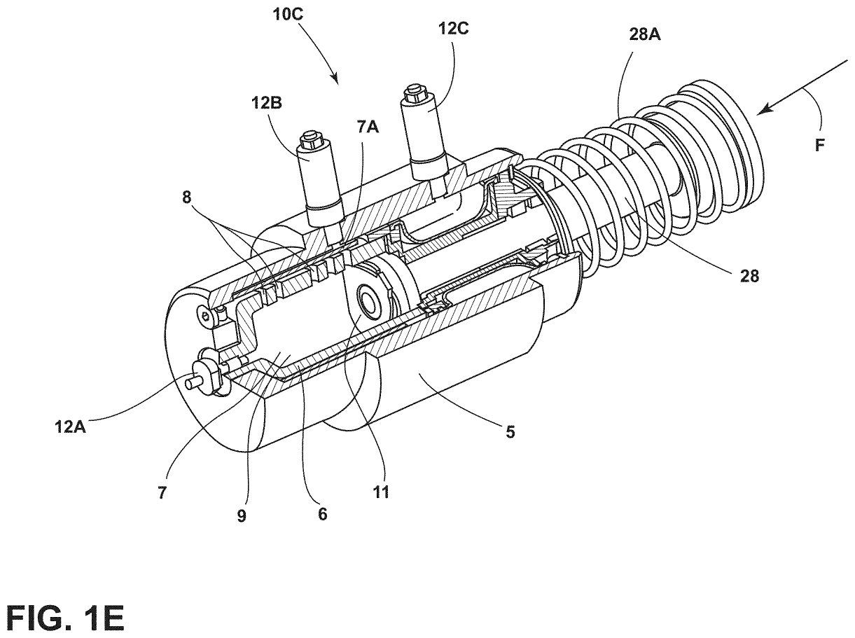

For purposes of description herein, the terms “upper,” “lower,” “right,” “left,” “rear,” “front,” “vertical,” “horizontal,” and derivatives thereof shall relate to the disclosure as oriented in FIG. 1. However, it is to be understood that the disclosure may assume various alternative orientations and step sequences, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

As used herein, the term “and/or,” when used in a list of two or more items, means that any one of the listed items can be employed by itself, or any combination of two or more of the listed items can be employed. For example, if a device is described as elements A, B, and/or C, the device can contain A alone; B alone; C alone; A and B in combination without C; A and C in combination without B; B and C in combination without A; or A, B, and C in combination, or more than one of each elements (e.g. AA alone, BB alone, CC alone, AAB in combination without C, ABB in combination without C, etc.).

As used herein, “comprises at least one of,” “including at least one of,” “including one or more of,” and all other open phrases followed by a list of items, features, or category (e.g. “at least one of A, B, or C,” or “at least one of A, B, and C,” “one or more of A, B, or C,” or “one or more of A, B, and C”) means at least one A by itself (e.g. A, AA, AAA, etc.), at least one B by itself (e.g. B, BB, BBB, etc.), at least one C by itself (e.g. C, CC, CCC, etc.), or any combination thereof (e.g. AB, AC, BC, ABC, AAB, ABB, AABB, AAC, ACC, AACC, BBC, BCC, BBCC, AABC, ABBC, ABCC, AABBC, AABBCC, ABBCC, AABCC, etc.).

Modifications of the disclosure will occur to those skilled in the art and to those who make or use the disclosure. Therefore, it is understood that the embodiments shown in the drawings and described above are merely for illustrative purposes and not intended to limit the scope of the disclosure, which is defined by the following claims, as interpreted according to the principals of patent law, including the doctrine of equivalents.

The present disclosure generally relates to industrial shock absorbers that may be utilized to decelerate a moving object. Industrial shock absorbers may utilized in a wide variety of applications such as in steel mills, lumber mills, shipping yards, warehouses, stacker spaces, automated storage and retrieval systems, production machinery, etc. For example, with reference to FIG. 1, system 1 may comprise a production system 1 or other industrial system, and may include machinery 2 including a stationary base and one or more moving components 3A, 3B, etc. that are decelerated by one or more shocks 10A, 10B having piston rods 28. In the illustrated example of FIG. 1, the machinery 2 converts raw materials 4A into finished products 4B. However, it will be understood that the present disclosure is not limited to any specific type of machinery or application. Shocks 10A and 10B may be substantially similar to the industrial shock absorbers 10, 10C, and associated monitoring system described in more detail below. In particular, shocks 10A and 10B may include one or more sensors 12, 46, 46A and/or sensors 12A, 12B, 12C (FIG. 1E) that are utilized to predict end-of-life and/or to detect failure and/or excessive wear. Sensors 12 may comprise pressure and/or temperature sensors, and sensors 46, 46A may comprise position sensors that provide signals concerning the positions (e.g. Rod-IN and/or Rod-OUT) of piston rods 28. Shocks 10A and 10B (or 10C) may also be operably connected to one or more remote devices or stations 16 that may be utilized to monitor shocks 10A and 10B.

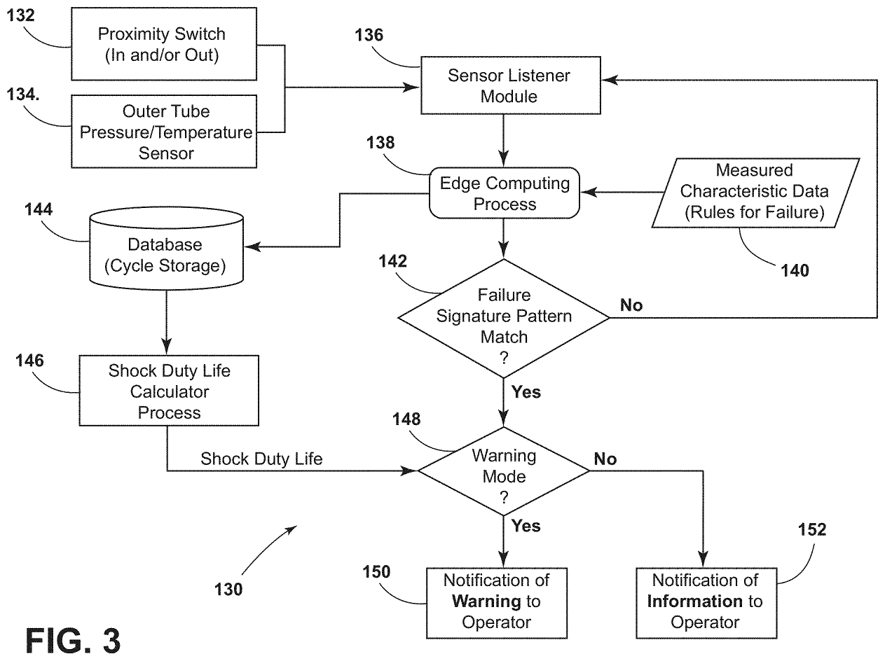

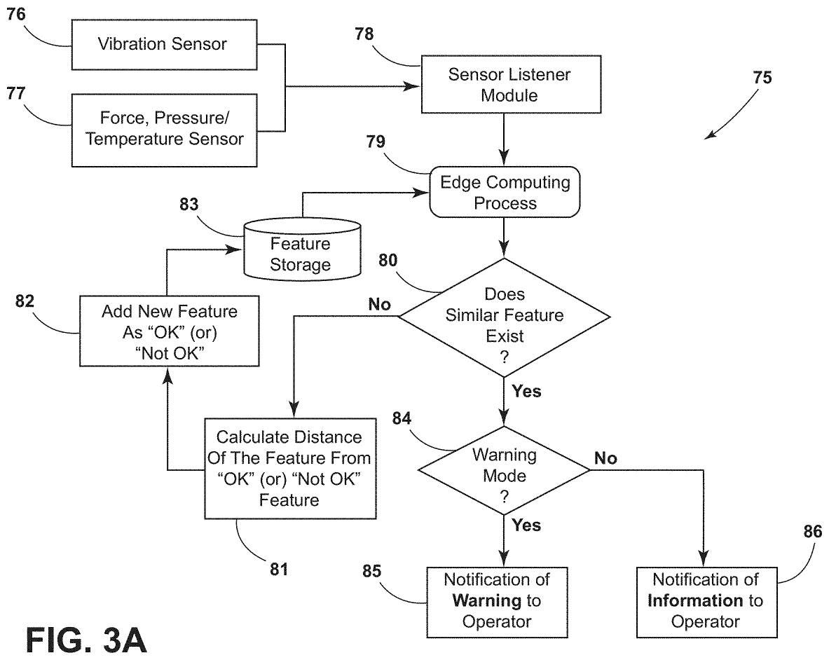

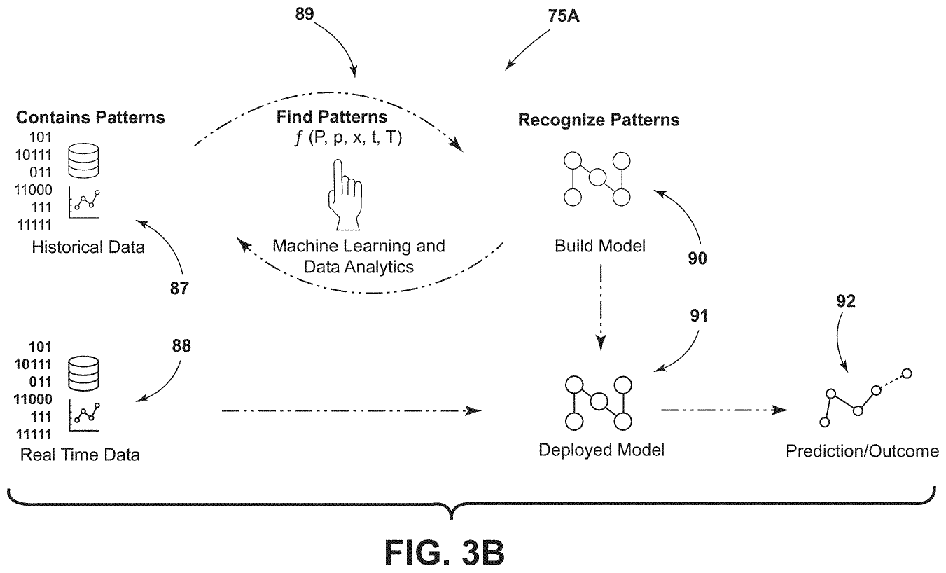

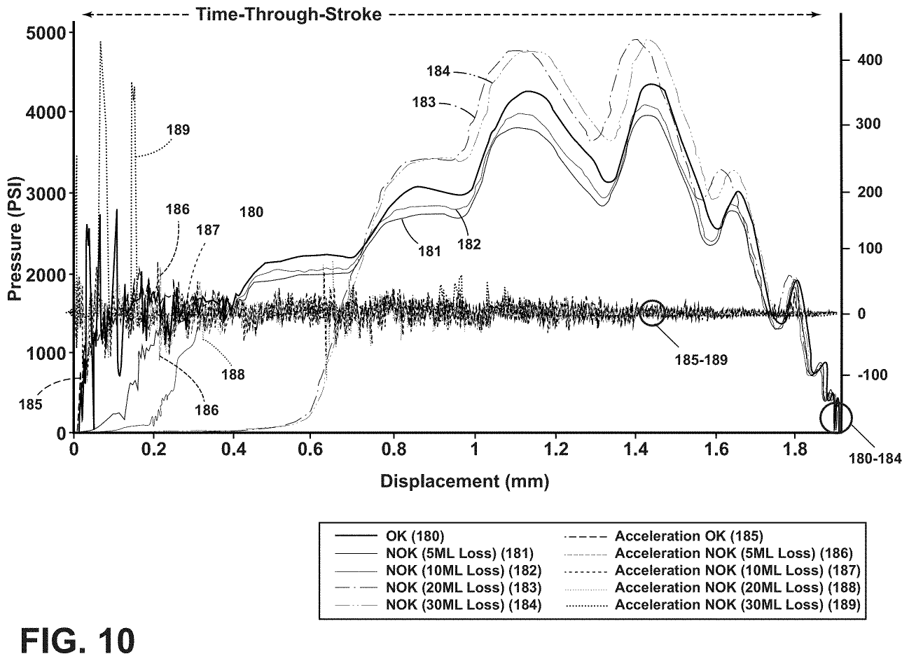

With further reference to FIGS. 1A-1B, shocks 10A and 10B may include a coil spring 28A that biases piston rod assembly 28 to an extended position (FIGS. 1A and 1D). When an external force “F” (FIG. 1B) is applied to the piston rod assembly 28, the piston rod shifts from the extended position of FIG. 1A to the retracted position of FIG. 1B due to the force “F”. When shocks 10A, 10B are installed in machinery 2 (e.g., FIG. 1 or other equipment), the moving part of the machinery may initially be spaced apart from the end of piston rod assembly 28 to define a gap, and the machinery component may then move into contact with piston rod assembly 28 to apply force “F”. After the force “F” is removed as shown in FIG. 1C, the bias of spring 28A causes piston rod assembly 28 to shift back to the extended position of FIG. 1D (i.e., the same extended position as FIG. 1A). In general, the Time-Through-Stroke (TTS) is the time required for the piston rod assembly 28 to shift (move) from the extended (rest) position of FIG. 1A to the compressed or retracted position of FIG. 1B. The Rod Return Time (RRT) shown in FIG. 1D is the time required for the piston rod assembly 28 to shift (move) from the retracted position of FIG. 1C to the extended (rest) position of FIG. 1D upon release of the force “F”. It will be understood that the shocks 10A, 10B of FIGS. 1 and 1A-1D or 10C (FIG. 1E) may include an external accumulator 30 (FIG. 3) and other such related components. As discussed below, Time-Through-Stroke (TTS) and Rod Return Time (RRT) can be determined during operation of an industrial shock absorber using sensors, and changes in Time-Through-Stroke (TTS) and/or Rod Return Time (RRT) over time may be used to detect and/or predict failure of the shock.

When installed in industrial machines or the like, an external force F may be repeatedly applied and released to piston rod assembly 28, thereby causing the shock assembly to cycle each time an external force F is applied and released. In general, during each cycle, the piston rod assembly 28 moves from the extended (rest) position to a retracted position while the external force F is applied to the piston rod assembly 28, and the piston rod assembly 28 then moves from a retracted position to the extended (rest) position when the external force F is released. It will be understood that the extended and retracted positions may not be identical during each cycle. For example, if the magnitude of the external force F is not identical during each cycle, the retracted position during each cycle may also vary. Variations in the length of time that an external force F is applied to the piston rod assembly 28 may also cause the retracted position to vary. In other applications, however, the magnitude and time of application of external force F may be the same or approximately the same during each cycle, such that the retracted position of the piston rod assembly 28 during each cycle is the same or approximately the same.

With further reference to FIG. 1E, an industrial shock absorber 10C according to an aspect of the present disclosure may include a cylinder 5 and an inner tube 6 disposed inside cylinder 5. Inner tube 6 includes an internal cavity 7 that is filled with oil or other suitable fluid. In use, movement of piston rod assembly 28 pressurizes oil 9 in cavity 7 of inner tube 6, and the oil 9 flows through orifices 8 to provide a force acting against an external force “F”. The configuration of the orifices 8 and other components may be designed to provide a desired force versus velocity profile as required for a particular application. Various orifices and/or other components may be utilized as required for a particular application.

The industrial shock absorber 10C may further include a pressure sensor 12A that measures the pressure of oil 9 in cavity 7 of inner tube 6 as rod 28 moves inwardly and outwardly during operation. The industrial shock absorber 10C may also include a sensor 12B that is configured to measure pressure and/or temperature of oil passing through passageway 7A between cylinder 5 and inner tube 6. Industrial shock absorber 10C may further include a sensor 12C that is configured to measure vibration of industrial shock absorber 10C (e.g., cylinder 5) during operation. Sensor 12C may comprise, for example, an accelerometer. The sensors 12A, 12B, and 12C may be operably connected to one or more computing devices 14 (FIG. 1) to provide for remote monitoring as discussed above in connection with FIG. 1.

As discussed in more detail below, sensors 12 may be utilized to monitor operating parameters (e.g. pressure and temperature), and sensors 46, 46A may be utilized to determine operating parameters such as Time-Through-Stroke (TTS) and/or Rod Return Time (RRT). TTS and RRT may be determined utilizing measured data from one or more of sensors 12, and sensors 46, 46A. Changes in these operating parameters may be utilized to predict a remaining life (or failure) of shock 10 and/or to detect a failure of shock 10. Also, if the Time-Through-Stroke (TTS) and/or Rod Return Time (RRT) do not match expected Time-Through-Stroke (TTS) and Rod Return Time (RRT) during initial operation, the system may determine that a failure has occurred even if the Time-Through-Stroke (TTS) and/or Rod Return Time (RRT) have not changed over time.

The system 1 may include a ground station 16 having one or more computing devices 14 that are operably connected to one or more sensors 12 of industrial shock absorber 10 or other sensors (e.g., sensors 12A, 12B, 12C of shock 10C). The sensor 12 and computing device 14 may include wireless transmitters and/or receivers to thereby communicate via a wireless signal 18. The wireless signal 18 may comprise a Wi-Fi signal, a Bluetooth signal, or the like. It will be understood that the sensor 12 may be connected to the computing device 14 utilizing a conventional conductive line or the like. Computing device 14 may also be configured to communicate with one or more remote devices 22 via a network or cloud 20 and/or cell towers 24 or other suitable communication devices. The remote device 22 may comprise a smartphone, computer or the like. For example, the remote device 22 may comprise a smartphone that is utilized by remote personnel to monitor the operation of the industrial shock absorber 10 and/or system 1. Remote device 22 may also comprise a computing device at a monitoring facility. For example, one or more remote devices 22 may be utilized at a centralized location to monitor a plurality of industrial shock absorbers 10 at a plurality of systems 1. In this way, a centralized monitoring facility may be utilized to simultaneously monitor numerous systems 1 at one or more geographic locations. It will be understood that computing device 14 of ground station 16 may be physically located outside of, or remote from the physical structure of ground station 16. Also, computing device 14 may comprise a plurality of computing devices that are interconnected. Thus, as used herein, the term “computing device” may comprise virtually any number of devices in any configuration that perform evaluation and/or monitoring. It will be understood that any of the shock absorbers and sensors of the present disclosure may be utilized in a system 1.

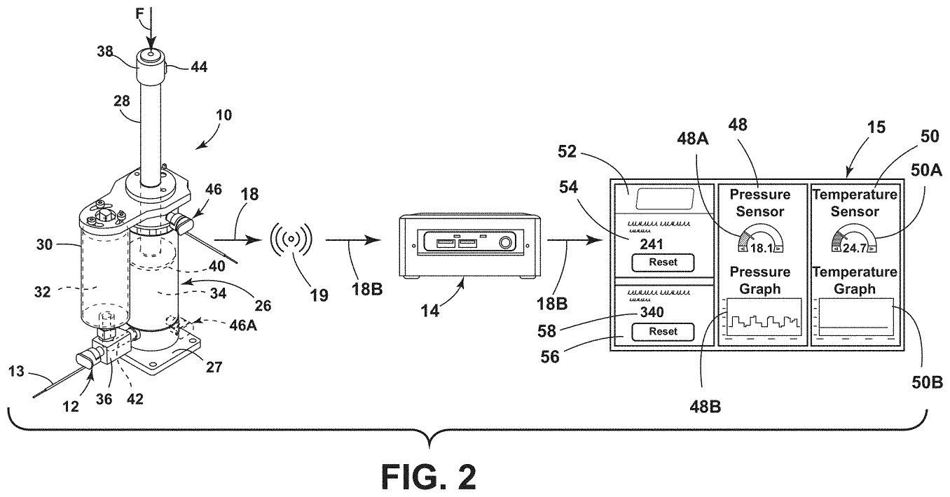

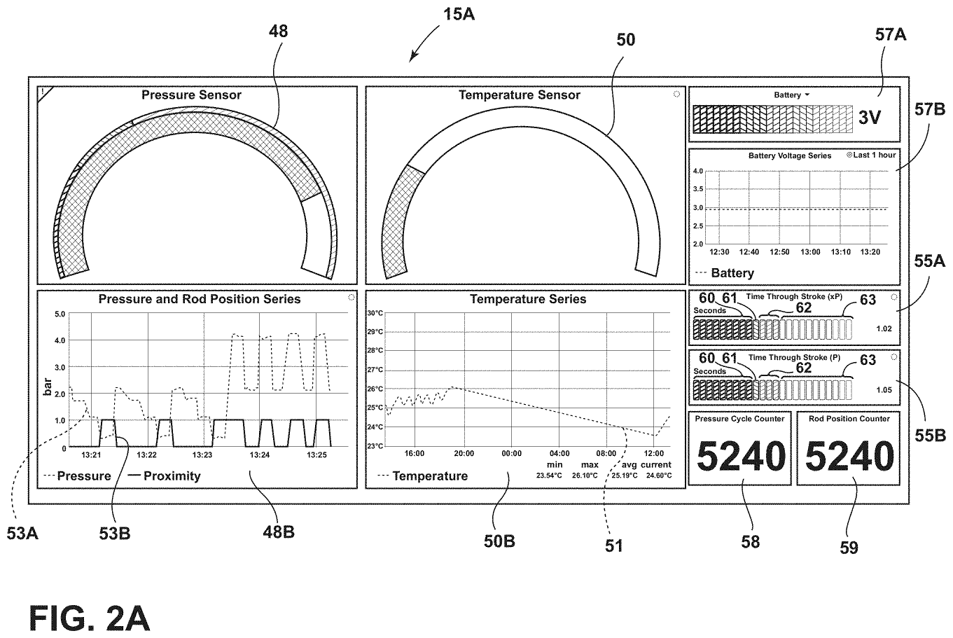

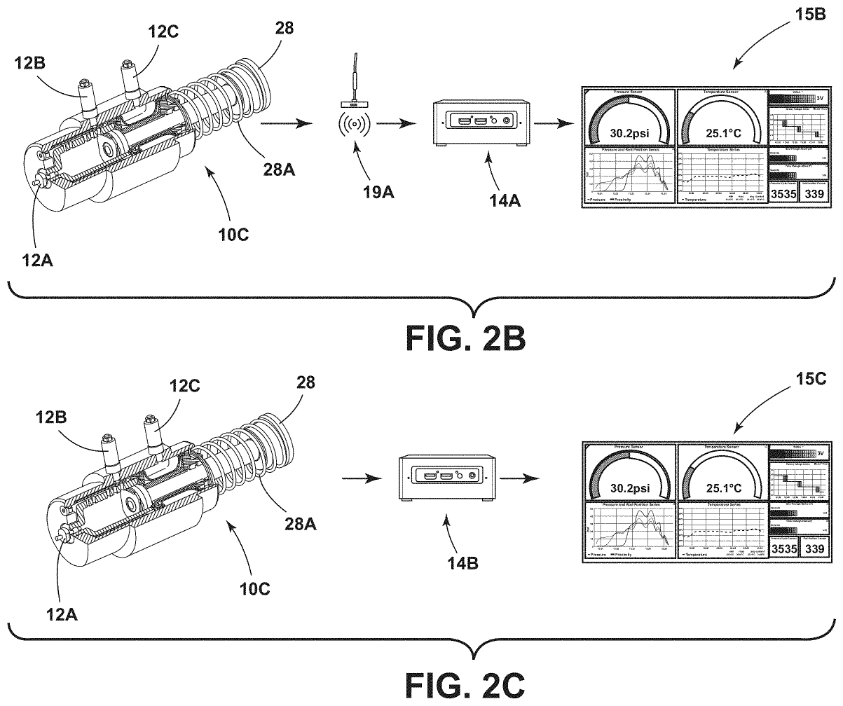

With further reference to FIG. 2, industrial shock absorbers 10A, 10B (FIG. 1) (and/or additional shocks of the system such as shock 10C may comprise an industrial shock absorber 10 having a body in the form of a cylinder 26 and a force-receiving member such as piston rod assembly 28. Industrial shock absorber 10 may include an external accumulator 30 having an internal chamber 32 that is fluidly connected to a main chamber 34 of cylinder 26 via a fluid passageway including fitting 36. Sensor 12 may be connected to fitting 36 such that the sensor 12 measures the pressure and/or temperature of working fluid (e.g. oil) passing through fitting 36. Thus, the sensor 12 may be configured to measure the pressure and/or temperature of fluid in chamber 32 of external accumulator 30. However, sensor 12 may be configured to measure pressure and/or temperature of working fluid in chamber 34 of cylinder 26. It will be understood that the system may include a plurality of sensors 12 to measure one or more of pressure and/or temperature of working fluid in chambers 32 and/or 34 and/or metering passageway 42 and/or any other suitable location. The industrial shock absorber 10 may include a bracket 27 or other suitable mounting structure to provide for mounting of the industrial shock absorber 10 to a structure of machinery 2 (FIG. 1) or the like. Sensor 12 preferably includes an antenna 13 to provide wireless communication with one or more devices such as computing device 14 of ground station 16 (FIG. 1).

In use, if a force “F” is applied to outer end 38 of piston rod assembly 28, the piston rod assembly 28 moves linearly, and piston 40 (inner end) of piston rod assembly 28 causes an increase in the pressure of working fluid (oil) in the main chamber 34 of cylinder 26. A metering passageway 42 and fitting 36 fluidly interconnect the main chamber 34 and the internal chamber 32 of external accumulator 30. The metering passageway 42 controls the flow of the working fluid from main chamber 34 to internal chamber 32 of external accumulator 30 in a manner that is generally known in the art. It will be understood that metering passageway 42 is shown schematically. The metering passageway 42 may include an inner tube (not shown) disposed inside cylinder 26 (outer tube) and the inner tube may include orifices (not shown). Various orifice (metering) configurations are known, and the present disclosure is not limited to any specific orifice/metering configuration.

The sensor 12 may be positioned in fluid communication with internal chamber 34 of external accumulator 30 to thereby measure one or more operating parameters of industrial shock absorber 10. The operating parameter may comprise at least one of pressure and temperature of the working fluid in external accumulator 30. However, it will be understood that the sensor 12 could alternatively (or in addition) be configured to measure the pressure and/or temperature of the working fluid in the metering passageway 42 or the main chamber 34.

A wireless sensor 44 may optionally be utilized to measure an operating parameter of industrial shock absorber 10 or 10C such as an acceleration of piston rod assembly 28. Sensor 44 may comprise a self-charging sensor including a battery that is charged upon movement of sensor 44. Sensors 46 and/or 46A may optionally be utilized to detect an operating parameter of industrial shock absorber 10. Sensor 46 may comprise a wireless proximity switch or other suitable sensor that may be configured to detect the presence of rod end 40 inside cylinder 26 when piston rod assembly 28 is in a fully extended position to thereby generate a “Rod-OUT” signal. When configured in this way, proximity sensor 46 may provide a limit switch. One or more proximity sensors 46A (e.g. proximity switches) may also be utilized to detect an operating parameter of industrial shock absorber 10. Sensor(s) 46A may comprise proximity switches that detect when piston rod assembly 28 is in a fully retracted (compressed) position. Thus, the system may be configured to detect operating parameters including fully extended (“Rod-OUT”) and/or fully retracted/compressed (“Rod-IN”) positions of piston rod assembly 28. Proximity switch or sensor 46 and/or switch or sensor 46A may be configured to send a wireless signal to computing device 14 when rod end 40 is detected (e.g. when piston rod assembly 28 is fully extended or fully compressed). Proximity sensors 46 and/or 46A may be utilized to determine a number of cycles shock 10 has experienced in use (e.g. since being installed in a system 1 or machinery 2) and/or other operating parameters (e.g. Time-Through-Stroke). Sensor 46A may be utilized to generate a “Rod-IN” signal that may also be utilized to determine a number of cycles of shock 10 and/or Time-Through-Stroke. As discussed below, signals from sensors 46 and/or 46A may be utilized to determine Time-Through-Stroke (TTS) and/or Rod Return Time (RRT) of piston rod assembly 28. US and RRT may be utilized to predict the remaining life of shock 10 and/or to detect failure or malfunction of shock 10. It will be understood that the remaining life (failure) of shock 10 may be determined based on predefined criteria such as degraded performance or likelihood of complete mechanical failure. Thus, failure according to the predefined criteria does not necessarily require that the shock ceases to function entirely.

Alternatively, sensor 46 and/or sensor 46A may comprise a position sensor that is configured to detect (measure) a position of piston rod assembly 28 relative to cylinder 26. The position data may be measured continuously or at very small time intervals (e.g. 1.0 seconds, 0.5 seconds, 0.1 seconds, 0.05 seconds, 0.01 seconds, 0.005 seconds, 0.0001 seconds, etc.), and the position and time data may be utilized to determine the velocity of piston rod assembly 28 during each cycle of shock 10 by numerically calculating a derivative of position with respect to time. It will be understood that a curve fit may be utilized on the measured data to provide a generally smooth (continuous) measured input data. The acceleration of piston rod assembly 28 may also be determined by taking (calculating) a second derivative of position with respect to time. As discussed in more detail below, data from sensor 12 and/or sensor 46 and/or sensor 46A (and/or sensors 12A, 12B, 12C) may be utilized to determine a predicted life of shock 10 (or 10C) and/or to determine if shock 10 (or 10C) has failed according to predefined failure criteria. Acceleration sensor 44 is not necessarily required if sensor 46 is configured to determine acceleration and/or if a life cycle prediction and/or failure criteria determination do not require acceleration. It will be understood that shock 10 (or 10C) may include sensors 12, 46, and 46A, only sensor 12, only sensor 46, only sensor 46A, or any combination of sensors 12, 12A, 12B, 12C, 46, 46A. Furthermore, the location, type, and number of sensors 12, 12A, 12B, 12C, 46, 46A, etc. may vary as required for a particular application, and the present disclosure is not limited to any specific number of sensors or types of sensors. In general, virtually any sensors capable of providing data relating to operating parameters and/or the number of cycles may be utilized.

Referring again to FIG. 2, the sensors 12 and/or 46 and/or 46A of industrial shock absorber 10 (and/or sensors 12A, 12B, 12C of shock absorber 10C) are configured to communicate with one or more computing devices 14 utilizing wireless signals 18 and 18A. It will be understood that virtually any communication means (e.g. wireless and/or hard lines) may also be utilized. The wireless signals from sensors 12 and/or 46 (and/or 12A, 12B, 12C) may be communicated via a wireless receiver node 19 that is configured to use Wi-Fi, MQTT, Bluetooth, LORA, NuBit, eSIM, GSM, Ethernet, Paho or other suitable wireless technology. The wireless receiver node 19 generates wireless signals 18B that are received by the computing device 14. The computing device 14 may comprise virtually any suitable computing device or combination of devices, and may be programmed to process data from sensors 12 and/or 46 and/or 12A, 12B, 12C of an industrial shock absorber 10 or 10C. It will be understood that, if required for a particular application, data from only one of sensors 12, 12A, 12B, 12C, 46, 46A, or data from any combination of the sensors may be utilized. The computing device 14 may be configured to receive data from a plurality of industrial shock absorbers 10 or 10C having sensors 12, and/or 46, and/or 46A, and/or 12A, 12B, 12C and the computing device 14 may be configured to process the data from multiple sensors 12 and/or 46. Each sensor 12, and/or 46, and/or 46A and/or 12A, 12B, 12C may have a unique identifier (e.g. a Serial No.), and data from each sensor 12, and/or 46, and/or 46A and/or 12A, 12B, 12C over time may be stored and retrieved using the Serial No. for processing and evaluation.

The computing device 14 is preferably configured to generate notifications that may be transmitted wirelessly via a signal 18B to a notification device such as a display screen 15 that may optionally be located at ground station 16 (FIG. 1). The notification device may alternatively comprise a smartphone 22 or other device that is located remote from the ground station 16. It will be understood that the system may include a plurality of screens and/or other suitable notification devices disposed at various locations.

Display 15 (FIG. 2) may include a first portion 48 that displays pressure data from sensor 12, and a second portion 50 that displays temperature data from sensor 12 and/or 12A, 12B, 12C. The pressure and/or temperature data may be displayed in graphic form and/or numerically, and/or in any other suitable manner. For example, the pressure sensor display may include a real-time display 48A showing current pressure readings, and a chart or graph 48B displaying pressure over time. Similarly, the temperature display may display the current temperature 50A and temperature over time 50B. The pressure and/or temperature displays may be continuously and rapidly updated.

Notification device 15 may include a pressure cycle display 52 that displays the number of pressure peaks 54 that an industrial shock absorber 10 (or 10C) has experienced. Pressure cycle display 52 may be provided utilizing pressure data from pressure sensor 12 and/or 12A, 12B, 12C. It will be understood that the number “241” shown in FIG. 2 is merely an example of a number of cycles that an industrial shock absorber 10 (or 10C) may have experienced in operation, and the number will increase over the life of industrial shock absorber 10 (or 10C). Notification device 15 may also include a rod position cycle counter display 56 that displays the number of cycles measured by proximity sensor 46 and/or sensor 46A. As discussed in more detail below, the system may be configured to detect and/or predict failure of one or more shocks 10 (or 10C) that are operably connected to the system based, at least in part, on data from sensor 12, and/or sensor 46, and/or sensor 46A and/or 12A, 12B, 12C.

With reference to FIG. 2A, a display or “dashboard” 15A according to another aspect of the present disclosure may include a pressure sensor indicator 48, a temperature sensor indicator 50, a pressure and rod position series display 48B, and a temperature series display 50B. Display 48B may include a data line or display 53A showing pressure measurements over time, and a rod position data line 53B showing rod position (e.g. Rod-IN or Rod-OUT) as a function of time. Display 50B includes a line 51 showing temperature from the temperature sensor over time. The display 15A may also include displays 57A and 57B showing the battery voltage of one or more batteries of sensors 12. Display 15A may also include a pressure cycle counter 58 and a rod position counter 59. In general, the number of cycles counted utilizing pressure (i.e. display 58) is equal to the number of cycles based on rod position data (i.e. display 59). However, differences in the counts may indicate an operational problem with the shock 10 or failures of one or more sensors utilized to generate the data for displays 58 and 59.

Display 15A may also include displays 55A and 55B showing Time-Through-Stroke (TTS). Display 55A may display the latest US, and display 55B may display the TTS for the preceding cycle. The displays 55A and 55B may include red colored bars or displays 60 corresponding to a TTS that is too low (i.e. the rod is traveling too fast) relative to predefined criteria. The display regions 61 may comprise yellow indicator bars that also indicate that the TTS is too fast, and green bars 62 may be utilized to indicate a TTS that is within a hand optimum or predefined acceptable range. The bars or displays 63 may comprise darker colors (e.g. brown, dark red), and may indicate that the US is too long (i.e. the rod is traveling too slow), and shock 10 may be failing or approaching failure. It will be understood that virtually any colors or display configurations may be utilized to indicate TTS. The displays 55A and 55B provide information to an operator concerning the TTS for the most recent cycle of the shock 10, and also for the cycle immediately preceding the most recent cycle.

The system may be configured to evaluate the data from sensor 12, and/or sensor 46, and/or sensor 46A and/or 12A, 12B, 12C over time to determine if a trend exists indicating that the industrial shock absorber 10 (or 10C) is no longer functioning properly and/or to predict a future failure of the industrial shock absorber 10 (or 10C). For example, an industrial shock absorber 10 (or 10C) may be subject to testing to gather empirical measurements of pressure, temperature, and/or other operating parameters over time, and this data may be utilized to develop criteria for predicting failure (e.g. sufficiently degraded performance) of an industrial shock absorber 10 (or 10C) in use. If testing shows that pressure and/or temperature and/or other data (e.g., force) typically changes over time (e.g. linear or exponential peak pressure decline as a function of a number of cycles) and if failure is likely to occur once peak pressure reaches or approaches a given value, the measured pressure data can be utilized to predict the remaining number of cycles for the life of the shock.

Also, if one or more industrial shock absorbers 10 (or 10C) are in use in a plurality of devices (e.g. a plurality of machines 2 or other devices (FIG. 1)), historical data for numerous industrial shock absorbers 10 (or 10C) can be gathered, stored, and evaluated to determine criteria for predicting future failure of the industrial shock absorbers 10 (or 10C). The computing device 14 may be configured to generate signals to one or more notification devices 15 (or 15A) to alert an operator and/or a remote facility to a failure and/or to provide an operator with an estimated lifespan (e.g. remaining number of cycles) for one or more industrial shock absorbers 10 (or 10C).

The one or more computing devices 14 may be operably connected to one or more remote devices 22. For example, remote device 22 (FIG. 1) may comprise a device or system at a central monitoring station or facility that is operably connected to a plurality of industrial shock absorbers 10 (or 10C) at a plurality of geographic locations. Engineers or other technical specialists at the monitoring center may monitor and evaluate the data received from the industrial shock absorbers 10A, 10B (FIG. 1) (or 10C) at one or more remote geographic locations to provide additional monitoring and alerts to operators or other personnel at the individual devices 1 and/or facilities/locations. This data may be utilized to develop additional criteria to predict shock lifespans, acceptable combinations of operating parameters, etc.

As discussed in more detail below, the system 1 may utilize a controller that is configured to predict the normal end-of-life of one or more industrial shock absorbers 10 (or 10C) and/or detect and/or predict failure based on the deterioration of the operating parameters (characteristics) of the industrial shock absorber 10 (or 10C). In general, the detected or predicted failure may be a premature failure, or a failure that is consistent with an expected life of industrial shock absorber 10 (or 10C), or a failure that is delayed beyond an expected shock life. The system may be configured to detect and evaluate deterioration of the operating parameters (characteristics), which can be profiled using failure signatures that are read by one or more of the sensors 12, 12A, 12B, 12C, 44, 46, 46A, etc. of the industrial shock absorbers 10 (or 10C).

Each sensor 12, 12A, 12B, 12C, 44, 46, 46A, etc. may optionally have a unique digital identifier (e.g. a Serial Number) which may be associated with each specific industrial shock absorber 10 (or 10C) to provide for live monitoring of the performance characteristics of each individual shock absorber 10 (or 10C) by collecting data for one or more of pressure, temperature, vibration, and/or other operating parameters. These signals (e.g. data) may be communicated to a ground control station 16 using a suitable wireless protocol such as Wi-Fi, Bluetooth, MQTT, LORA, NuBit, Ethernet, Paho, etc., or other suitable arrangement.

The system may be configured to provide information regarding the number of cycles that each industrial shock absorber 10 (or 10C) has experienced (e.g. cycle counters 54 and/or 58, FIG. 2). The computing device 14, or other computing device, may be configured to determine information regarding the number of cycles, US, and RRT based on information calculated from pressure peaks and/or rod position during each impact on the industrial shock absorber 10 (or 10C). The system may be configured to compute the end-of-life of each industrial shock absorber 10 (or 10C) based on the number of cycles and/or the operating temperature and/or TTS and/or RRT and/or virtually any other measured variable (operating parameter) of each industrial shock absorber 10 (or 10C).

The computing device 14 and/or other computing facilities of the ground station (or remote facility) may optionally be configured to perform edge computing on the signals from each unique digital asset (sensor) over time, and compare the values with a historical data set stored in the computer device 14 or other device. The system may be configured to utilize an algorithm that conditions the values and profiles the failure type based on the collected sensor readings/data. Based on the failure profile, a notification may be sent to an operator or other facility, and additional actions may then be performed. The ground control station 16 may be configured to provide a live relay of the performance characteristics of one or more industrial shock absorbers 10 (or 10C) in a dashboard view (e.g. notification devices 15, 15A, 15B, 15C, FIGS. 2, 2A, 2B, and 2C) to one or more operators and/or remote personnel.

The system provides a solution wherein the performance values (failure and/or warning criteria) can be calibrated by engineers or other technical personnel so that the algorithms can be modified (if necessary) and used to detect specific failures based on the needs of a specific user. The system may be configured as required for various types of machinery and devices. Also, the system may be configured to predict failure for specific types or sizes of industrial shock absorbers 10 (or 10C). Thus, the system may be modified to provide failure prediction and/or warning for specific types/sizes of shocks 10 (or 10C), and/or the particular application. For example, a specific size and type of shock 10 (or 10C) may be used in a first machine (e.g. 3A, FIG. 1) and an identical shock 10 (or 10C) may also be used in a second machine (e.g. 3B, FIG. 1) having a significantly different configuration. In use, the pressures, temperatures, Time-Through-Stroke (TTS) and Rod Return Time (RRT) may be significantly different due to differences between the first and second machines. The operating parameter criteria utilized to determine shock failure and/or shock failure prediction may (optionally) be different for the two different machines. For example, a 25 psi measured pressure could trigger a “caution” type warning for a first machine 3A, whereas the same 25 psi pressure could trigger a “failure” warning for a second machine 3B.

The sensors 12A, 12B, and 12C of industrial shock absorber 10C (FIG. 1E) may be operably connected to a display 15B (FIG. 2B) by a wireless node 19A and computing device 14A in a manner that is substantially similar to the arrangement discussed in more detail above in connection with FIG. 2. Similarly, with reference to FIG. 2C, the sensors 12A, 12B, and 12C of industrial shock absorber 10C may be operably connected to a display 15C using a wired connection. It will be understood that communication lines (e.g., wires) may be utilized to operably connect the sensors 12A, 12B, and 12C to a computing device 14B and display 15C. However, use of electrical lines or the like is generally known, such that the electrical lines are not shown in FIG. 2C.

With further reference to FIG. 3, a process 130 according to another aspect of the present invention utilizes data 132 from proximity sensor (e.g. switch) 46 and/or 46A and pressure and/or temperature data 134 from a sensor 12. It will be understood that the sensors may comprise wireless sensors, or the sensors may be connected to computing device 14 and/or other devices utilizing conductive lines. At step 136, the data 132 and/or data 134 is processed, and then transferred to edge computing service listener at step 138. Steps 136 and 138 may be performed by a wireless device and/or a computing device. Measured data 140 is also supplied to edge computing service listener 138, and data is transferred to database 144. The database 144 may comprise one or more computing devices.

The measured data 132 and 134 is transferred to step 142, and the system (e.g. one or more processors) determines if the data satisfies predefined failure criteria. If not, the process loops back to step 136. However, if the system determines that the measured data meets predefined failure criteria (discussed below), the system proceeds to step 148. At step 148, the system utilizes shock duty life calculation data from step 146, and determines if a warning mode is to be implemented. If a warning mode is to be implemented, the system proceeds as shown at step 150, and the system provides a warning to the operator. If the system determines that a warning mode is not required at step 148 (i.e. warning criteria has not been satisfied), the system proceeds to step 152, and notification information is provided to an operator. In general, the warning and/or information of steps 150 and 152 may be provided by a display screen, audio device, or a warning can be transmitted remotely to other devices 22 such as smartphones, laptop computers, and/or centralized computing devices and systems at a central monitoring facility and/or at other locations.

The system may be configured to utilize machine learning pattern analysis “ML” to determine if shock 10 has failed, or is likely to fail. A machine learning process 75 (FIG. 3A) utilizes one or more inputs from a vibration sensor 76 and/or force, pressure, and temperature sensor 77 (e.g., sensors 12A, 12B, 12C, FIG. 1E). The data from sensor 76 and 77 is received by a sensor listener module 78, and the data is then provided to an edge computing process 79. The output from the edge computing process 79 is utilized at step 80 to determine if a similar feature exists. In general, step 80 determines if a measured pattern is sufficiently similar to a “problem” pattern according to predefined criteria. If a similar feature does exist, the system determines if a warning 85 or information 86 should be generated at decision step 84. If a similar feature does not exist (step 80), the process calculates a distance of the measured feature (pattern) from an acceptable (“OK”) or unacceptable (“not OK”) feature at step 81. At step 82, the system adds the new feature as “OK” or as “not OK.” The feature (with its “OK” or “not OK” designation) is stored in a features storage shown schematically at step 83. The “OK” and “not OK” features of step 83 are utilized at edge computing process 79 to provide input to step 80.

A machine learning process according to another aspect of the present disclosure is shown schematically in FIG. 3B. In general, the machine learning process 75A may include preconfigured historical data patterns 87 for an industrial shock absorber (e.g., industrial shock absorber 10C, FIG. 1E) which has been sized for a specific application. This information is stored in database installed within an edge computing device 14 which may be configured to perform deep learning of the industrial shock absorber during its operation. The machine learning process 75A may comprise algorithms which study (recognize) anomalies, outlier conditions and predicted outcomes by comparing real-time data 88 with patterns from historical data 87. As shown schematically at step 89, the system may be configured to find patterns and conduct machine learning and data analytics to recognize patterns 90 and build a model 91 to thereby provide a prediction/outcome 92. Thus, the system may be configured to utilize predefined failure criteria programmed into the system prior to (or during) installation and/or the system may develop new failure criteria via machine learning whereby the failure criteria may be updated or modified during operation of the system.

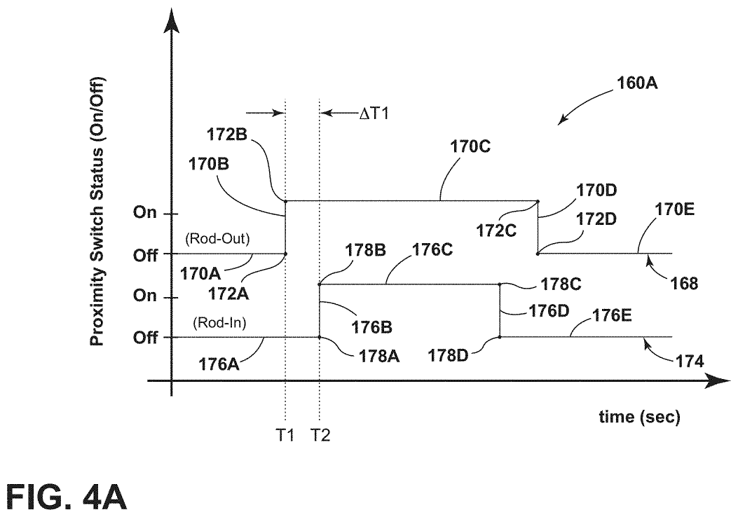

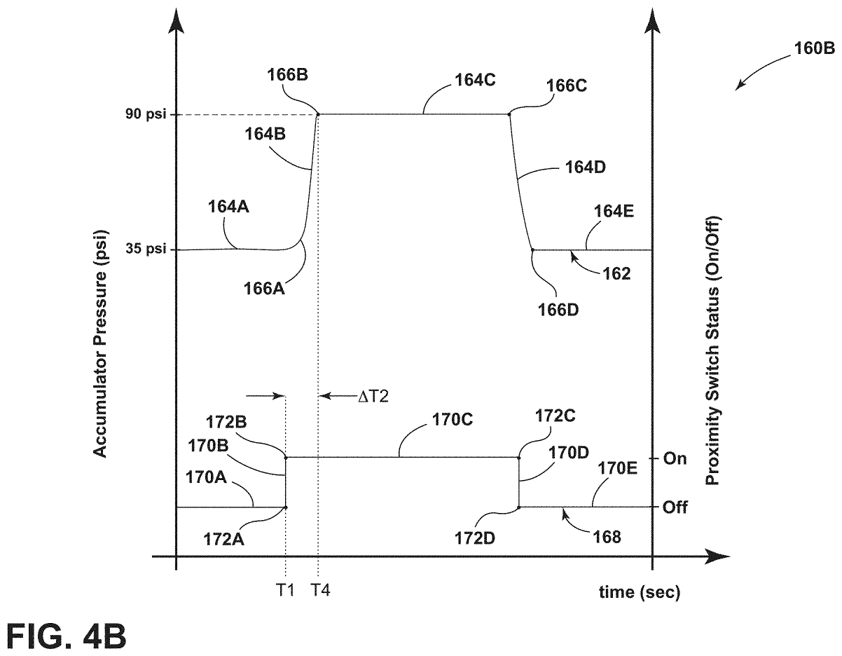

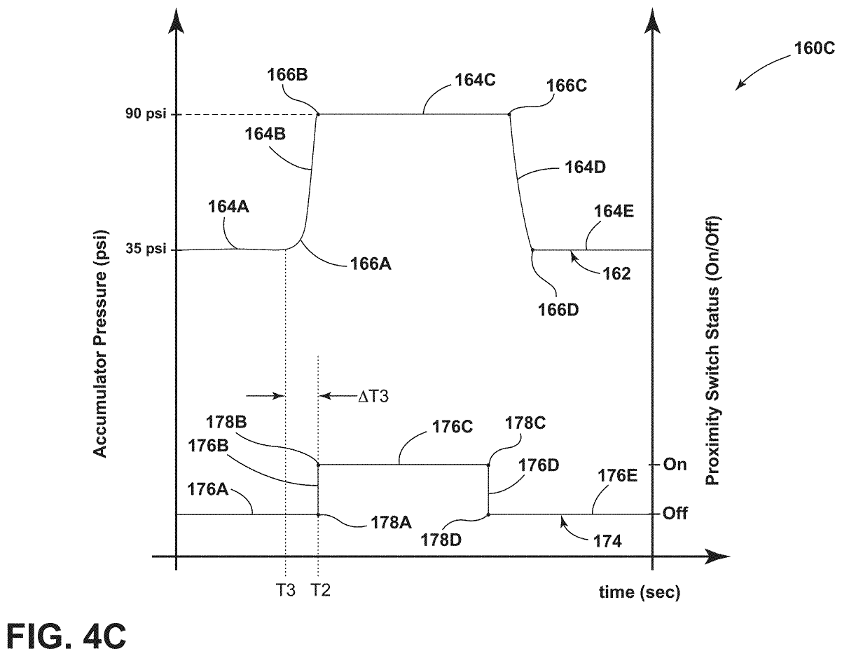

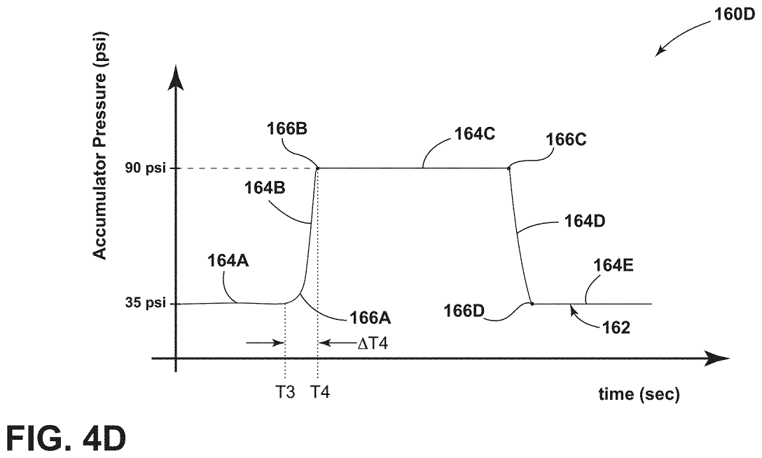

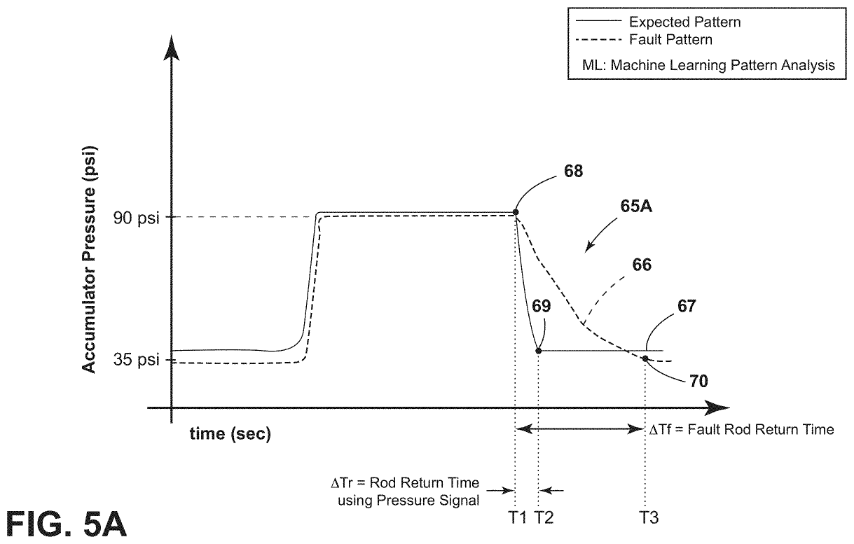

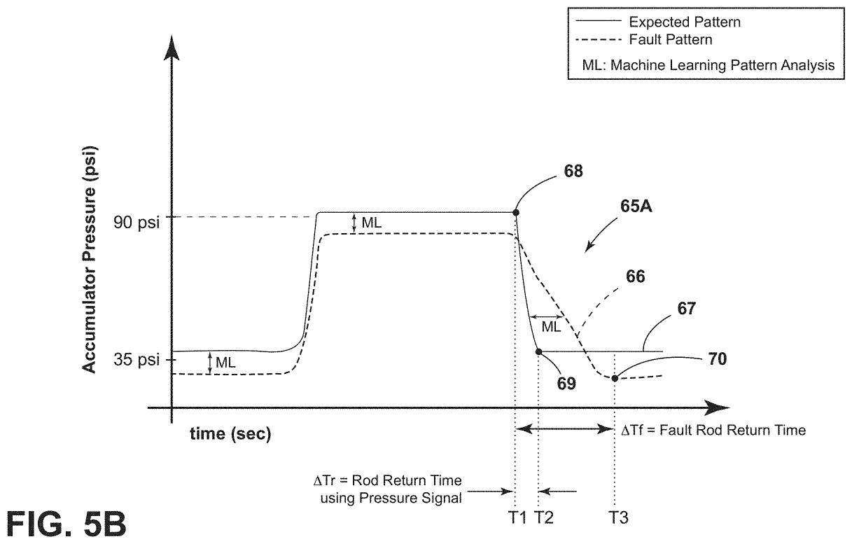

As discussed in more detail below, in connection with FIGS. 5A-7B, the machine learning of FIGS. 3A and 3B may be utilized to detect and/or predict failure using measured data from one or more sensors. FIGS. 4A-4D are schematics showing various criteria that may be utilized to determine Time-Through-Stroke (TTS) operating parameters ΔT₁-ΔT₄, respectively, of a shock 10 (or 10C) using sensor data. As discussed in more detail below, FIG. 4A illustrates calculation of TTS using two proximity sensors (Rod-OUT and Rod-IN). In general, a Rod-OUT sensor will be “On” when the rod is extended (e.g., FIGS. 1A and 1D) and a Rod-IN sensor will be “On” when the rod is retracted (e.g., FIGS. 1B and 1C). FIGS. 4B and 4C illustrate calculation of TTS using the signal from one proximity sensor (either Rod-OUT or Rod-IN) along with a pressure signal from the accumulator. FIG. 4D illustrates the calculation of TTS using only a pressure signal (e.g. from the accumulator).

It will be understood that the measured TTS may not correspond exactly to the time required for the piston rod to move from the extended position to the retracted position. For example, the Rod-OUT and Rod-IN sensors may be positioned such that an “On” condition occurs before the piston rod is fully OUT (extended) and fully IN (retracted). Nevertheless, unexpected TTS measurements and/or changes in TTS over time may be utilized to detect and/or predict shock failure.

Furthermore, it will be understood that the approaches of FIGS. 4A-4D could be combined in any combination. For example, the TTS could be determined utilizing a plurality of approaches (e.g. 2 or more of the approaches of FIGS. 4A-4D), and an average TTS could be determined. The average TTS could be utilized to determine and/or predict industrial shock absorber failure. It will be understood that FIGS. 4A-4D are schematic in nature, and the actual signals from the switches and sensors may vary according to a particular application.

In FIGS. 4A-4D, the vertical line “T₁” represents the time at which a signal 168 from a Rod-OUT switch (sensor) transitions from “Off” to “On.” The line “T₂” represents the time at which a Rod-IN signal 174 from a switch (sensor) transitions from an “Off” state to an “On” state. As shown in FIG. 4D, the time “T₃” represents the time at which a pressure signal 162 begins to increase during a cycle, and the time “T₄” represents the time at which the pressure signal transitions to a horizontal or constant value.

With reference to FIG. 4A, sensor data 160A comprises sensor readings from a Rod-OUT proximity switch (line 168), and a Rod-IN proximity switch (line 174). Lines 168 and 174 of FIG. 4A represent the “On” and “Off” states of the Rod-OUT and Rod-IN proximity switches, respectively. Line 168 includes horizontal “Off” segments 170A and 170E, and a horizontal “On” segment 170C. The vertical line segments 170B and 170D represent the transitions from the “Off” state to the “On” state and vice versa. Points 172A-172D represent the transitions between these line segments. Similarly, the line 174 includes horizontal “Off” portions 176A and 176E, and a horizontal “On” segment 176C, and vertical transition line segments 176B and 176D. The points 178A-178D represent the transitions between the horizontal and vertical line segments. ΔT₁ is the Time-Through-Stroke (TTS) operating parameter, which may be calculated by taking the difference between the times of vertical lines T₁ and T₂.

With reference to FIG. 4B, ΔT₂ represents the US, which is equal to the distance between vertical lines T₁ and T₄. Sensor data 160B includes a pressure signal line 162 from the accumulator, which generally incudes a first horizontal line segment 164A (baseline pressure) that transitions to a sloped line segment 164B at a radiused corner 166A as the pressure initially increases during a cycle. The pressure then levels off as shown by horizontal line segment 164C extending between points 166B and 166C. The pressure then drops as shown by the line segment 164D extending between points 166C and 166D, and transfers to a horizontal (baseline) pressure as shown by horizontal line segment 164E. It will be understood that the line 162 is representative, and the actual line segments 164A-164E may not be completely linear, and the transitions 166A-166D may comprise points, curves, etc. The Time-Through-Stroke ΔT₂ (TTS) of FIG. 4B may be calculated by taking the distance between vertical lines T₁ and T₄.

Measurement criteria may be utilized to generate a plurality of pressure measurements (i.e. line 162; FIG. 4B) and proximity switch measurements (i.e. line 168) over a period of time while the shock is in use to thereby permit changes in the ΔT₂ (TTS) operating parameter over time to be determined. The changes in ΔT₂ (TTS) over time can be utilized to predict the end-of-life of a shock 10 (or 10C) and/or to detect deterioration in the performance of a shock 10 that may be indicative of wear or problems that may indicate that a shock 10 (or 10C) is approaching end-of-life, even if the changes in the ΔT₂ (TTS) operating parameter do not constitute an actual (complete) failure or end-of-life of the shock.

With reference to FIG. 4C, a Time-Through-Stroke Δ₃ (TTS) operating parameter for sensor data 160C may be calculated by determining a distance between times T₃ and T₂. As noted above, time T₃ represents the time at which the pressure signal 162 begins to increase, and the time T₂ represents the transition of the Rod-IN signal 174 from the “Off” state to the “On” state.

With reference to FIG. 4D, Time-Through-Stroke ΔT₄ (TTS) operating parameter for sensor data 160D may be calculated by taking the difference between the times T₃ and T₄. The times T₃ and T₄ represent the times at which the pressure signal 162 initially begins to increase (T₃), and the time at which the pressure signal 162 transitions to a relatively constant value (T₄).

The system may be configured to determine the Time-Through-Stroke (TTS) operating parameter utilizing one or more of the approaches shown in FIGS. 4A-4D, and the Time-Through-Stroke (TTS) data for a given shock may be stored. For example, the system may be configured to determine only a single Time-Through-Stroke (TTS) (i.e. one of ΔT₁, ΔT₂, ΔT₃, or ΔT₄). Alternatively, the system may be configured to utilize a combination of the US calculations. Also, TTS may be calculated utilizing only proximity sensor data (i.e. only line 168, only line 174, or lines 168 and 174).

Furthermore, other operating parameter criteria may be utilized to determine if a shock is degrading and/or to predict the end-of-life of a shock 10 (or 10C). For example, with reference to FIG. 4D, the pressure (line 162) may initially vary between 35 psi (baseline pressure) and 90 psi (peak pressure) for a given shock 10 (or 10C). However, over time, one or both of these pressures may decline, and this decline could be utilized to predict shock wear and/or end-of-life of a shock 10 (or 10C). For example, a failure of a shock 10 (or 10C) may be defined as a peak pressure that is less than 60 psi, and the system may be configured to generate a failure signal if the peak pressure drops below 60 psi. Also, if the peak pressure over time declines from 90 psi to (for example) 70 psi, this decline can be extrapolated to predict a time or number of cycles at which the pressure is predicted to drop below 60 psi. This end-of-life prediction can be continuously updated and conveyed to users at ground station 16 and/or a remote facility or device 22 (FIG. 1). This information may be provided on display screen 15 (FIG. 2) or other suitable device. It will be understood that the information may also be provided in an audio form in connection with a visual display or solely as an audio signal.

Time-Through-Stroke (TTS) changes over time can also be utilized to predict end-of-life of a shock 10 (or 10C) and/or to detect failure of shock 10 (or 10C). In general, the Time-Through-Stroke (TTS) for a shock 10 will be approximately the same each time a shock 10 (or 10C) is exposed to the same load. In some applications (e.g. production machinery), a shock 10 may be exposed to a force of a specific magnitude in a repetitive manner (i.e. the magnitude of the load is the same for each cycle). If a shock 10 (or 10C) begins to wear and/or experiences a failure, the Time-Through-Stroke for the shock 10 (or 10C) may decrease even if the loads applied to the shock 10 (or 10C) over time are substantially the same. Thus, the Time-Through-Stroke Stroke (TTS) operating parameter for a shock 10 (or 10C) over time may be utilized to predict end-of-life and/or to detect failure. For example, if empirical data shows that a given shock 10 (or 10C) has a high probability of failure once the Time-Through-Stroke (TTS) operating parameter drops to a predefined critical time, this predefined Time-Through-Stroke (TTS) time may be utilized to predict end-of-life (e.g. the Time-Through-Stroke (TTS) data over time can be used to extrapolate to a number of cycles at which the shock 10 (or 10C) will reach the critical Time-Through-Stroke (TTS) time).

Empirical data concerning shock failure and corresponding operating data (parameters) may be utilized to predict shock end-of-life. The empirical data may be utilized to determine correlations between the measured operating conditions/parameters (e.g. pressure, temperature, number of cycles, Time-Through-Stroke (TTS), etc.), and the data can be utilized to extrapolate measured data (operating parameters) in shocks 10 (or 10C) that have not failed to predict the end-of-life of a given shock 10 (or 10C). For example, a plurality of end-of-life predictions may be determined for a given shock 10 (or 10C) utilizing different criteria (e.g. both pressure criteria and Time-Through-Stroke criteria), and the criteria providing the shortest predicted shock life may be utilized to generate a warning if the end-of-life is predicted to be approaching. It will be understood that the various end-of-life predictions may be continuously recalculated and conveyed to operators at ground station 16 and/or to a remote device or facility 22. Furthermore, the criteria utilized to predict end-of-life for a given shock 10 (or 10C) may be modified over time if additional data is developed showing that variations in the end-of-life prediction provided more accurate ways to predict the end-of-life of a shock 10 (or 10C).

Rod Return Time (RRT) (FIG. 1D) may also be measured using one or more sensors, and unexpected RRT or changing RRT may be utilized to predict and/or detect shock failure. For example, with further reference to FIGS. 5A and 5B, a measured pressure 66 may vary from an expected pressure data line 67. If the rod pressure follows the expected line 67, this generally indicates that the shock 10 (or 10C) is operating properly, and the shock has not worn excessively or experienced significant damage. In this case, the Rod Return Time (RRT) ΔTᵣ is the difference between the vertical lines T₁ and T₂. Line T₁ corresponds to a time at which the pressure begins to drop (i.e. point 68), and the time T₂ corresponds to the point 69 at which the pressure stops dropping and returns to a baseline pressure.

When first installed (used) a shock 10 (or 10C) will typically have a ΔTᵣ that is consistent with an expected value. However, if the shock 10 (or 10C) is worn, or experiencing other failure, the measured pressure 66 may deviate from the expected pressure 67, and the pressure may transition at a point 70 corresponding to a time T₃. In this case, the RRT is equal to a Fault Rod Return Time ΔT_{f} comprising the difference between the times T₁ and T₃. The Fault Rod Return Time ΔT_{f} may comprise a failure criteria such that the system generates an alert or warning to display 15 (FIG. 2) or display 15A (FIG. 2A) if the RRT is equal to or greater than ΔT_{f}.

In the illustrated example, the Fault Rod Return Time ΔT_{f} is significantly greater than the expected Rod Return Time ΔATᵣ. The system may be configured to determine if the difference between the ΔTᵣ and ΔT_{f} is large enough to meet predefined failure criteria (e.g. step 142, FIG. 3), and provide a warning or information to an operator. In general, the difference between ΔTᵣ and ΔT_{f} may be continuously calculated and updated over time as the shock 10 (or 10C) cycles, and the changes in the difference between ΔTᵣ and ΔT_{f} may be utilized to predict shock failure. With further reference to FIG. 5B, the system may also be configured to implement machine learning “ML” to recognize changes and/or patterns of change between measured and expected pressure (lines 66 and 67, respectively). In particular, the system may be configured to implement the machine learning processes described above in connection with FIGS. 3A and 3B to detect and/or predict failure of shock 10 (or 10C). This machine learning process may be utilized in addition to predefined failure criteria. For example, the machine learning process may determine that a failure has occurred based on differences ML (FIG. 5B) even if the measured RRT is still less than the Fault Rod Return Time ΔT_{f}.

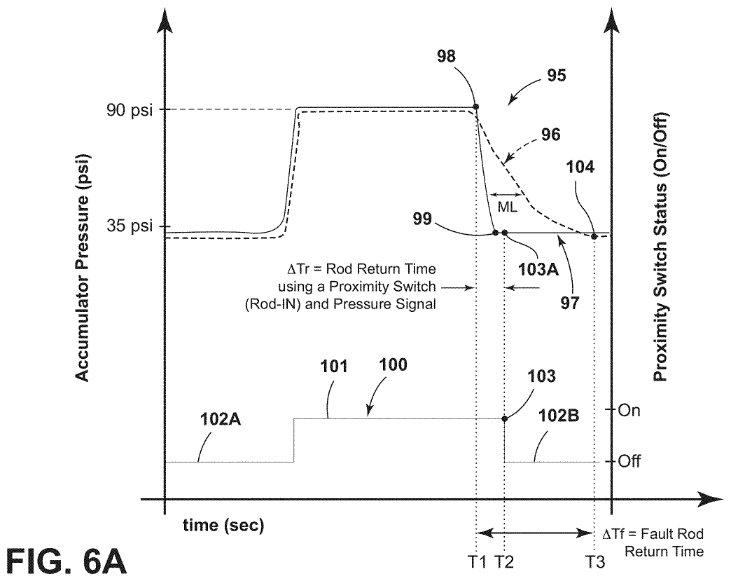

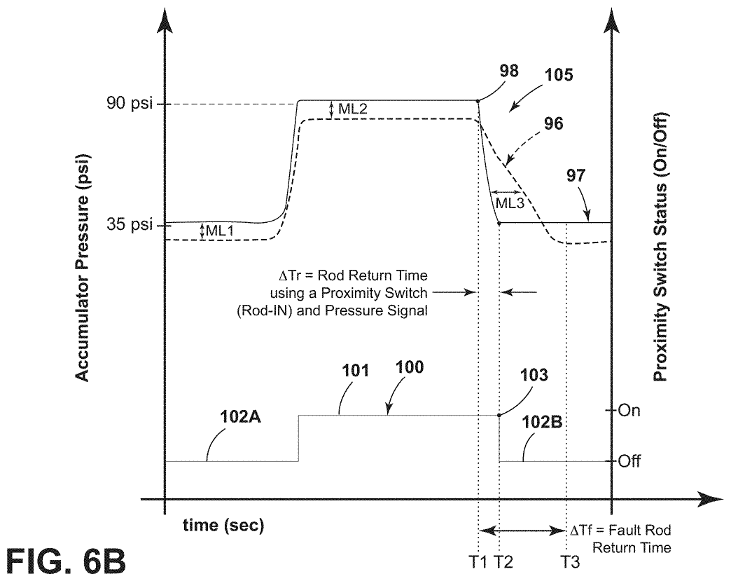

With reference to FIG. 6A, line 96 shows a measured pressure and line 97 shows an expected pressure signal from the sensors that are operably connected to the shock 10. In general, line 96 of FIG. 6A may be similar to the line 66 of FIG. 5A and the line 97 of FIG. 6A may be similar to the line 67 of FIG. 5A. As the shock 10 (or 10C) wears, the measured pressure 96 may vary from the expected pressure 97, and this difference may be recognized utilizing machine learning “ML” as described above. The expected pressure 97 transitions from high pressure to low pressure at points 98 and 99. Chart 95 of FIG. 6A also includes a line 100, which represents a signal from a proximity switch (Rod-OUT) having portions 102A and 102B corresponding to an “Off” signal, and a portion 101 corresponding to an “On” signal.

The pressure signal line 96 and/or pressure signal line 97 can be utilized in conjunction with the proximity switch signal 100 to determine Rod Return Time (RRT). In particular, the RRT ΔTᵣ can be calculated as the horizontal distance between the lines T₁ and T₂. The line T₁ corresponds to point 98 at which the accumulator pressure begins to drop, and the vertical line T₂ represents point 103 at which proximity switch satisfies 100 shifts to “Off” at point 103. The Fault Rod Return Time ΔT_{f} is the horizontal distance (i.e. difference) between the vertical lines T₁ and T₃. ΔT_{f} may comprise a predefined failure criteria, and the system may be configured to generate a warning signal if the measured RRT is equal to ΔT_{f}, or if the measured RRT is sufficiently close to the ΔT_{f}. The vertical line at T₃ intersects point 104 of measured pressure line 96. Point 104 is the point at which the measured pressure 96 transitions from a downward slope to a horizontal slope. It will be understood that the measured pressure 96 may vary somewhat, such that a “sharp” transition from decreasing pressure to horizontal pressure may not be readily apparent. Accordingly, the system may be configured to determine the slope of line 96 and determine the location of point 104 according to predefined criteria (e.g. if the slope of line 96 is zero or sufficiently small). Furthermore, the measured pressure line 96 may be smooth or curve fit to reduce variations to avoid incorrectly determining the location of point 104 based on small variations in measured pressure 96.

With reference to FIG. 6B, a chart 105 is somewhat similar to chart 95 of FIG. 6A, and includes a measured pressure line 96, and an expected pressure line 97. Chart 105 also includes a proximity switch line 100 corresponding to the “On” and “Off” states of the proximity switch. In FIG. 6B, the measured pressure line 96 has further shift relative to the expected pressure line 97, thereby forming three regions ML₁, ML₂, and ML₃ at which the measured pressure line 96 is spaced apart from the expected pressure line 97. The system may be configured to utilize the differences ML₁, ML₂, and ML₃ utilizing machine learning as discussed above in connection with FIGS. 3, 3A, and 3B to determine if failure has occurred or is predicted to occur. In general, in FIG. 6B, the measured (RRT) ΔTᵣ may be determined by taking the difference between lines T₁ and T₂, and the Fault Rod Return Time ΔT_{f} can be determined by taking the difference between the lines T₁ and T₃. Thus, in FIG. 6B, ΔTᵣ and ΔT_{f} are determined in the same manner as discussed above in connection with FIG. 6A. However, because one or more of lines T₁, T₂, and T₃ may shift, the numerical values of ΔTᵣ and ΔT_{f} of FIG. 6B may not be equal to the values in FIG. 6A. It will be understood that the actual shapes of the lines 96, 97, and 100 for a given shock 10 (or 10C) may have somewhat different shapes than the lines of FIGS. 6A and 6B. Furthermore, the changes in the shapes of the lines (e.g. measured pressure line 96) could vary in numerous ways as the shock 10 (or 10C) is used, and FIGS. 6A and 6B merely illustrate one possible example. ΔT_{f} may comprise predefined failure criteria, and the measured ΔTᵣ may be compared to ΔT_{f} to determine if a failure has occurred or is predicted to occur.

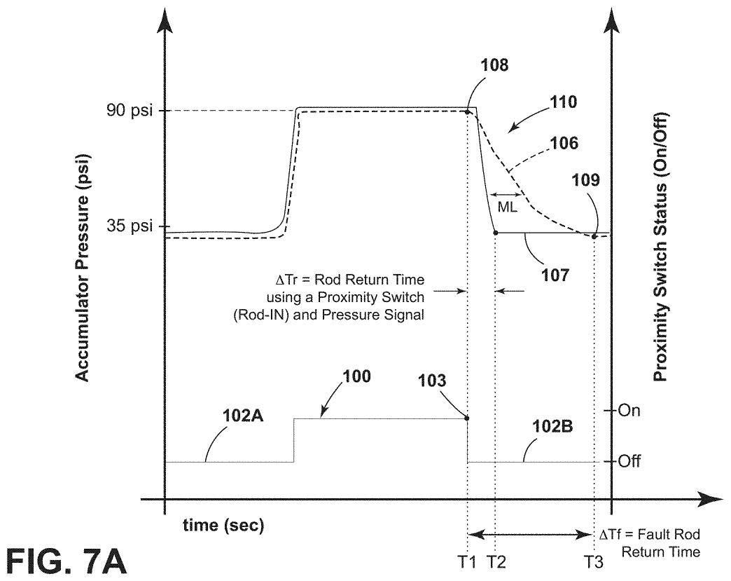

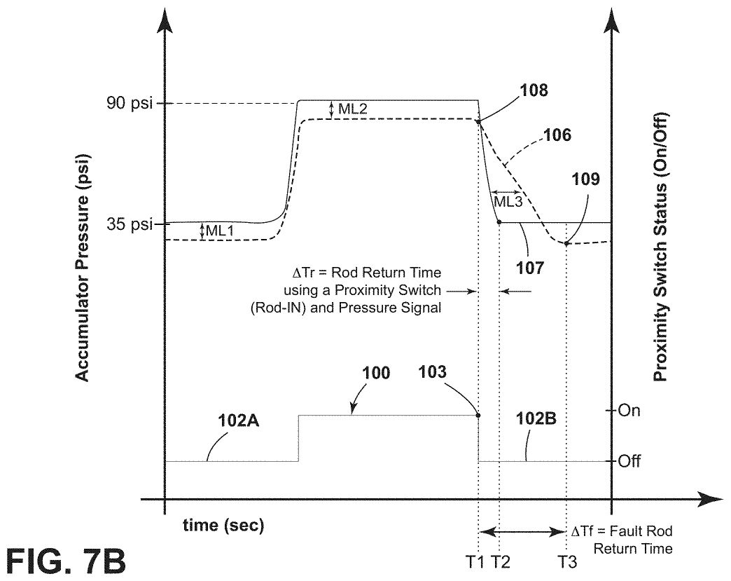

With further reference to FIGS. 7A and 7B, the Time-Through-Stroke ΔTᵣ may be determined by taking the difference between vertical lines T₁ and T₂, and the Fault Rod Return time ΔT_{f} may be calculated by taking the difference between vertical lines T₂ and T₃. As noted above, the signal line 100 of FIGS. 6A and 6B corresponds to the “On” and “Off” states of a Rod-OUT proximity switch. In contrast, the line 100 of FIGS. 7A and 7B corresponds to the “On” and “Off” status of a Rod-IN proximity switch. Accordingly, the horizontal location of the point 103 of line 100, which corresponds to the change in state from “On” to “Off” of the proximity switch is shifted to the left in FIGS. 7A and 7B relative to the position of point 103 in FIGS. 6A and 6B. In general, the signal 100 transitions from “On” to “Off” in FIGS. 7A and 7B as the rod begins to shift from the “On” position. The differences ML, ML₁, ML₂, and ML₃ between the measured pressure 106 and expected pressure 107 in FIGS. 7A and 7B can be utilized by the machine learning process of FIGS. 3, 3A and 3B to identify variations in the measured pressure, and/or wear or other malfunctions in shock 10 (or 10C), and generate warning and/or failure signals to a display 15 (FIG. 2) or 15A (FIG. 2A).

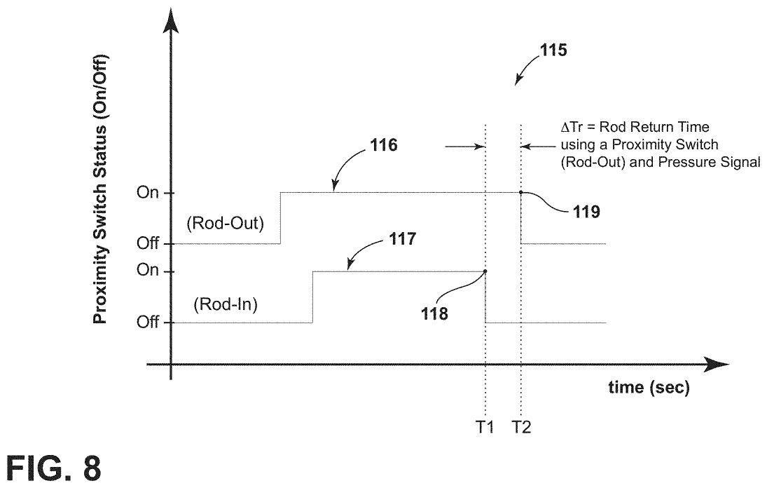

With further reference to FIG. 8, a chart 115 includes a signal line 116 of a Rod-OUT proximity switch, and a line 117 corresponding to the status of a Rod-IN limit switch. FIG. 8 corresponds to a configuration of shock 10 (or 10C) having both Rod-IN and Rod-OUT proximity switches. The Rod Return Time ΔTᵣ may be determined by taking the difference between vertical lines T₁ and T₂. Vertical T₁ corresponds to point 118 at which the Rod-IN status line 117 transitions from “On” to “Off”, and line T₂ corresponds to point 119. Point 119 is the point at which the Rod-OUT status 116 transitions from “On” to “Off”. Variations in the RRT may be utilized by the machine learning processes to predict failure and/or detect malfunctions of shock 10 (or 10C).

The system may be configured to provide information regarding the number of cycles the industrial shock absorber 10 (or 10C) has experienced based on information calculated from the piston rod extension state and/or the pressure during each impact on the industrial shock absorber 10. The system may be configured to combine data from the proximity switches with the pressure signal to calculate the Time-Through-Stroke (TTS) as described above in connection with FIGS. 4A-4D.

One or more of the Rod Return Time (RRT) determinations of FIGS. 5A-8 may also be utilized to determine the end-of-life of industrial shock absorber 10 (or 10C) based on one or more of the number of cycles, the TTS, the RRT, and the operating temperature of the industrial shock absorber 10 (or 10C). The system (e.g. ground station 16; FIG. 1) may be configured to perform edge computing on signals from each unique sensor over a period of time and compare the values with historical data. The system may be configured to condition the values and profile the failure type based on the collected sensor readings. Based on the failure profile, a notification may be sent to the operators of the system or to a central (e.g. remote) engineering facility for any actions that may need to be performed. The ground control station 16 may be configured to provide a live relay of the performance characteristics of one or more selected industrial shock absorbers 10 (or 10C) displayed in a dashboard view (e.g. FIGS. 2 and 2A) to the operators. The system may also provide information concerning the battery status within the sensor or sensors as discussed above in connection with FIG. 2A, and notify the operators whenever battery replacement is required.

The system offers the possibility for the performance values to be calibrated by engineers or other technical personnel so that the algorithms can be reused for handling specific failure detection based on the specific requirements for a particular application of the shock 10 (or 10C). For example, the pressure value for a system warning could be adjusted to a specific application. The system may be configured to offer functionality where platform updates in the ground station software can be flashed from the cloud using Flash Over the Air (FOTA) protocol. The collected data sets from each digital assert may be uploaded to the cloud/server space and users may compare the characteristic values of the industrial shock absorber 10 (or 10C) from the day of origination.

The system may be configured to immediately detect faults and/or failures of shock 10 (or 10C) and communicate them to one or more operators. The system may immediately notify a smartphone, smart watch, send emails, send phone messages (SMS), etc. The system may offer the functionality of a cycle counter based on pressure data during cycles of shock activation. The system may offer the functionality of a cycle counter based on the rod position state using a proximity switch, which may be wired or wireless. The system may be configured to determine TTS using only a pressure signal. The system may be configured to combine data from a proximity switch with a pressure signal to calculate TTS based on the approaches discussed above in connection with one or more of FIGS. 4A-4D.

The system may be configured to utilize the data of two proximity switches (Rod-OUT and Rod-IN) to calculate TTS as discussed above in connection with FIG. 4A. The system may be configured to monitor TTS and provide a failure notification when the measured and/or calculated values fall outside of normal parameters as shown in one or more of FIGS. 4A-4D.

The system may be configured to determine RRT using only the pressure signal as shown in FIGS. 5A and 5B. The system may be configured to combine data from one proximity switch with the pressure signal to calculate RRT as described in more detail above in connection with FIGS. 6A, 6B, 7A, and 7B. The system may also be configured to combine data from two proximity switches to calculate RRT as described above in connection with FIG. 8.

The system may be configured to monitor RRT and provide failure notification when the measured and/or calculated values fall outside of the normal (expected) parameters as shown in one or more of FIGS. 5A-8. The system may also offer functionality to predict the industrial shock absorber end-of-life (EOL) based on the number of cycles and operating conditions. The system may be configured to use the TTS parameters to detect industrial shock absorber state of health, which may be used in an EOL prediction model. The system may be configured to record the history of some or all parameters to facilitate detection of industrial shock absorber deterioration using predefined criteria.

The system may be configured to perform machine learning on the real-time data from the industrial shock absorber 10 (or 10C) with a focus on deep learning. It compares this data with historical data that is either programmed into the base data or learned during function of the industrial shock absorber 10. The machine learning algorithms can then identify anomalies, outliers, and predict unique failures of the industrial shock absorber 10 (or 10C) by comparing the real-time data with patterns from the historical data or models.

The system may be configured to notify operators when deviations from the predicted outcome occur, and provide additional information concerning the possibility of fault or failures in the industrial shock absorber 10 (or 10C) which may or may not identify the time of system installation and/or assembly.

The system may be configured to detect failures that occur, and may communicate the failures immediately so that the failures can be addressed as rapidly as possible to prevent further damage and/or to improve safety. Eliminating or reducing the costs resulting from further damage may provide a significant improvement compared to existing systems. The system of the present disclosure may be configured to predict industrial shock absorber EOL to provide for optimal preventative maintenance in manufacturing or other environments to maximize up-time and minimize costs. The system may also be configured to predict earlier than normal failures and permit for preemptive measures to avoid damage to equipment or other items.

The system may be configured to directly measure TTS and/or RRT using two proximity switches including a Rod-OUT switch and a Rod-IN switch. The system may be configured to calculate TTS and RRT with only the pressure signal. Alternatively, the system may be configured to calculate TTS and RRT utilizing a combination of rod proximity switch status and pressure data. The system may be configured to perform notifications in the event instantaneously TTS or RRT failures occur. The TTS and RRT failures may be determined by comparing current TTS and/or RRT failures to expected values and/or historical TTS and/or RRT values measured by the system.

The system may be configured to perform historical analysis and machine learning on the real-time RRT to predict the present or future probability of failure. The TTS and RRT patterns may be utilized to predict industrial shock absorber EOL. The system may include machine learning algorithms deployed within the edge computing device which perform deep learning of the industrial shock absorber during its operation. The machine learning algorithms may be configured to study anomalies, outlier conditions, and predict outcomes by comparing the real-time data with patterns from the historical model. Operators may be notified of deviations from the predicted outcome, and the operators may be provided with additional information concerning the possibility of faults or failures in the industrial shock absorber 10 (or 10C) which may or may not have been identified at the time of system assembly and/or installation.

The system and method of the present disclosure may be utilized to predict normal industrial shock absorber end-of-life to offer optical preventive maintenance in manufacturing environments to maximize up-time and minimize cost. It may also be configured to predict earlier than normal failures and allow for preemptive measures to avoid damage. The system may be configured to detect failures that occur and to communicate the failures immediately so that failures can be addressed quickly to prevent further damage and to include safety. In this way, the system may provide significant cost savings.

The system may include a ground control unit that has pre-loaded characteristic curves for failure of signatures. Based on raw data from the sensors, the ground controlling unit may compare peak signals and pattern analysis of raw data with the built in characteristic curve to identify patterns and predict failure.

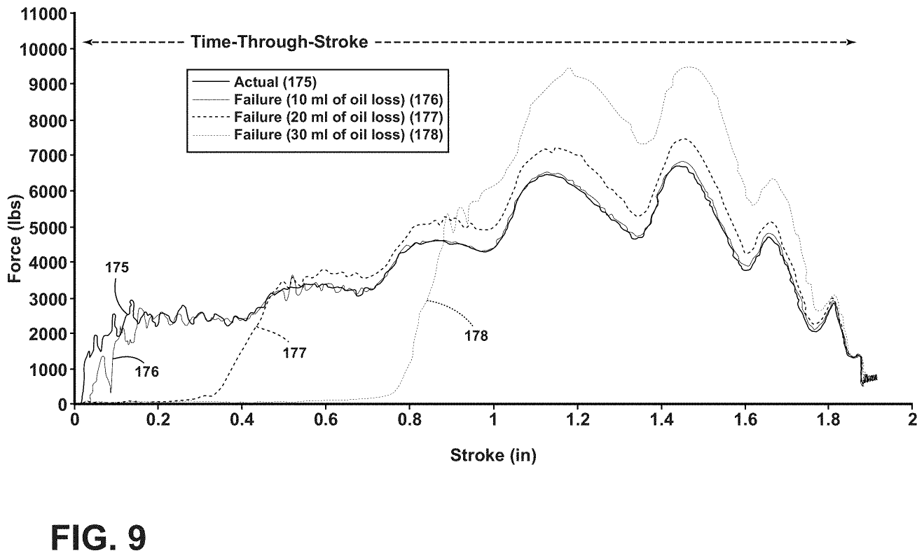

With further reference to FIG. 9, lines 175-178 represent measured force as a piston rod assembly 28 shifts from an extended position (e.g., FIG. 1A) to a retracted position (e.g., FIG. 1B). In general, the Time-Through-Stroke (TTS) is the time required for rod 28 to shift from an extended position to a retracted position when an external force “F” is applied to the piston rod assembly 28. The line 175 represents normal operation of an industrial shock absorber 10C in a given application. It will be understood that the actual force may vary depending on the size and configuration of the shock 10C and the size and type of machinery or other equipment that applies a force to the piston rod assembly 28.

Referring again to FIG. 9, line 176 is a measured force if the industrial shock absorber 10C has lost some oil (e.g., 10 ML). The loss of oil corresponding to line 176 may constitute a failure. In general, as discussed above in connection with FIGS. 3A and 3B, the system (e.g., computing device 14, 14A, 14B, 14C, etc.) may be configured to implement the machine learning and pattern recognition process described in more detail above in connection with FIGS. 3A and 3B. Accordingly, the system may be configured to detect deviation of line 176 relative to line 175, and provide a warning or information as shown schematically as 85 and 86 in FIG. 3A. Lines 177 and 178 represent a failure due to a loss of 20 ML and 30 ML of oil, respectively. In general, additional loss of oil may result in force versus displacement (stroke) data that deviates more significantly from the actual or baseline data of line 175. The system may be configured to notify an operator of greater deviation (failure) as the measured data deviates further and further from the actual or baseline data 175.

In general, the force may be measured utilizing sensor 12A (FIG. 1E). Sensor 12A may comprise a pressure sensor, and the force may be calculated utilizing the area of end 11 (FIG. 1E) of piston rod assembly 28. Alternatively, sensor 12A may comprise a force sensor (e.g., piezoelectric sensor) that is mounted between, for example, cylinder 5 of industrial shock absorber 10C and a structure of a machinery (e.g., FIG. 1) to thereby directly measure the force shown in FIG. 9. Piston rod assembly 28 may include an end 11 having an inner surface facing cavity 7. As discussed in more detail below, a pressure measured by sensor 12A can be utilized to calculate force based on the area of end 11. In general, this measured force is equal to the product of the pressure measured by sensor 12A and the area of end 11. It will be understood that this measured force may be somewhat less than the applied force “F” due to friction as rod assembly 28 moves relative to inner tube 6.

With reference to FIG. 10, the Time-Through-Stroke (TTS) can also be calculated utilizing inner tube pressure (i.e., the pressure of oil in cavity 7 measured by sensor 12A) (FIG. 1E) for the acceleration of rod assembly 28 as measured by acceleration sensor 44 (FIG. 2). Lines 180-184 of FIG. 10 represent measured pressure as a function of the displacement of rod assembly 28, and lines 185-189 represent acceleration of rod assembly 28 as a function of displacement. Specifically, line 180 corresponds to a baseline or non-failure pressure, and lines 181-184 represent pressures at oil losses of 5 ML, 10 ML, 20 ML, and 30 ML, respectively. In general, as the measured pressure deviates from the expected or normal data (line 180), the system may detect the changing patterns and warn or notify an operator as discussed in more detail above in connection with FIGS. 3A and 3B.

Referring again to FIG. 10, line 185 represents a normal, non-failure acceleration measured by sensor 44, and lines 186, 187, 188, and 189 represent acceleration when the shock has experienced an oil loss of 5 ML, 10 ML, 20 ML, and 30 ML, respectively. The system may be configured to recognize deviations in the measured acceleration data relative to an expected or normal acceleration data, and notify or warn an operator if a failure condition is detected as discussed in more detail above in connection with FIGS. 3A and 3B.

Also, the measured data lines shown in FIGS. 9 and 10 may also be utilized to calculate Time-Through-Stroke (TTS). Specifically, with reference to FIG. 9, the lines 175-178 begin to move upwardly as the piston begins to move through its stroke. In the illustrated example, the actual force 175 increases rapidly at the beginning of the stroke. The system may be configured to determine that this rise constitutes a beginning of the stroke, and the system may further be configured to determine that a drop in the measured force constitutes an end of the stroke, and the time required from the beginning of the stroke to the end of the stroke is the measured Time-Through-Stroke (TTS). As oil is lost (e.g., lines 177-178), the force may not increase significantly until the piston rod has moved a significant distance. Thus, the system may detect a beginning of a stroke after the piston rod has moved significantly (e.g., the portions of lines 177 and 178 that initially increase above zero), and the measured (e.g., calculated) Time-Through-Stroke (TTS) is therefore reduced for lines 177 and 178 because the time required to return to zero force is reduced. Similarly, the system may be configured to determine (calculate) Time-Through-Stroke (TTS) utilizing the pressure and/or acceleration data of FIG. 10. Thus, changes in measured (calculated) TTS and/or RRT may be utilized to detect and/or predict shock failure even if the actual time for the piston rod to extend and/or retract (FIGS. 1A-1D) does not change significantly. Also, the sensors may be configured such that the measured (calculated) TTS and/or RRT do not correspond exactly to the actual time required for the piston rod to extend and retract. However, expected TTS and/or RRT for a given shock in a particular application may nevertheless be utilized to detect and/or predict shock failure.

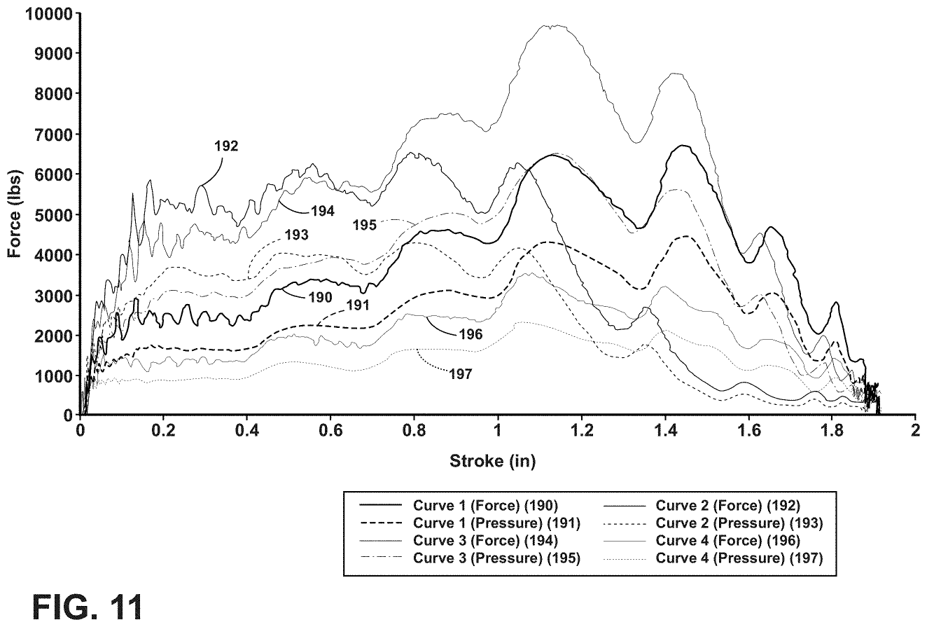

With further reference to FIG. 11, various baseline or good (non-failure) data lines 190-197 may be developed for various industrial shock absorbers in various applications. These lines (data) may be utilized by the system to detect changes in patterns over the life of an industrial shock absorber in a particular application. It will be understood that the curves of FIG. 11 are merely examples, and the actual curves for a particular application will vary depending on the type of machinery, the size and configurations of the industrial shock absorber, etc. In the illustrated example, lines 190 and 191 correspond to force and pressure, respectively, for an industrial shock absorber in a first application. Similarly, lines 192 and 193 correspond to force and pressure, respectively, for an industrial shock absorber in a second application. Lines 194 and 195 correspond to force and pressure for an industrial shock absorber in a third configuration/application. Lines 196 and 194 correspond to force and pressure, respectively, for an industrial shock absorber in a fourth configuration/application.

The above description is considered that of the illustrated embodiments only. Modifications of the processes will occur to those skilled in the art and to those who make or use the processes. Therefore, it is understood that the embodiments shown in the drawings and described above are merely for illustrative purposes and not intended to limit the scope of the disclosure, which is defined by the following claims as interpreted according to the principles of patent law, including the Doctrine of Equivalents.

The invention claimed is:

1. An industrial shock absorber system for industrial machines, the shock absorber system, comprising:
an industrial shock absorber having a body defining a cavity and a piston rod having an inner end movably disposed in the cavity whereby, in use, movement of the piston rod relative to the body upon application of an external force to the piston rod from a rest position to a retracted position causes movement of a working fluid whereby the working fluid resists movement of the piston rod, and wherein the shock absorber is designed and configured to absorb energy when a movable member that is initially spaced-apart from the force-receiving member to form a gap therebetween moves to close the gap and comes into contact with the force-receiving member to move the force-receiving member from the rest position to the retracted position;
a resilient member biasing the piston rod towards the rest position;
wherein, in operation, 1) the time required for the piston rod to move from the rest position to the retracted position defines a Time-Through-Stroke (TTS), and 2) the time required for the piston rod to move from the retracted position to the rest position upon release of an external force on the piston rod, and wherein movement of the piston rod from the rest position to the retracted position and then back to the rest position defines a cycle;
a sensor configured to generate measured sensor data corresponding to at least one of a pressure of the working fluid, a temperature of the working fluid, a position of the piston rod relative to the body, an acceleration of the piston rod, and a force applied to the piston rod; and
at least one computing device operably coupled to the sensor, wherein the computing device is configured to utilize predefined expected sensor data to determine if measured sensor data from the sensor is sufficiently dissimilar from the predefined expected sensor data to indicate that a failure of the industrial shock absorber has occurred and/or to determine if changes in sensor data over time indicate that failure has occurred and/or that failure of the industrial shock absorber is likely to occur.

2. The industrial shock absorber system of claim 1, wherein:
in use, the sensor data forms data patterns over time;
the computing device is configured to utilize machine learning to detect and/or predict failure of the industrial shock absorber by detecting changes in the data patterns over time.

3. The industrial shock absorber system of claim 1, wherein:
the computing device is configured to immediately detect faults and/or failures and communicate the faults and/or failures to an operator of the industrial shock absorber system.

4. The industrial shock absorber system of claim 1, wherein:
the computing device is configured to determine a number of cycles that have occurred during a predefined time interval utilizing measured pressure data from the sensor.

5. The industrial shock absorber system of claim 1, wherein:
the computing device is configured to determine a number of cycles based on measured position data corresponding to a position of the piston rod.

6. The industrial shock absorber system of claim 1, wherein:
the computing device is configured to determine the TTS using only measured pressure data.

7. The industrial shock absorber system of claim 1, wherein:
the computing device is configured to determine the TTS using measured force data.

8. The industrial shock absorber system of claim 1, including;
Rod-IN and Rod-OUT proximity switches; and wherein:
the computing device is configured to determine the TTS using data from the Rod-IN and Rod-OUT proximity switches.

9. The industrial shock absorber system of claim 1, wherein:
the industrial shock absorber system is configured to monitor the TTS and provide a failure notification if a magnitude of the TTS is not within a predefined acceptable range.

10. The industrial shock absorber system of claim 1, wherein:
the computing device is configured to determine the RRT using only pressure data.

11. The industrial shock absorber system of claim 1, wherein:
the computing device is configured to determine the RRT using acceleration data and/or force data.

12. The industrial shock absorber system of claim 1, including:
Rod-IN and Rod-OUT proximity switches; and wherein
the computing device is configured to determine the RRT using data from the Rod-IN and Rod-OUT proximity switches.

13. The industrial shock absorber system of claim 1, wherein:
the system is configured to monitor the RRT and provide a failure notification if the magnitude of the RRT is not within a predefined range.

14. The industrial shock absorber system of claim 1, wherein:
the system is configured to predict end-of-life of the industrial shock absorber based, at least in part, on the number of cycles and operating conditions.

15. The industrial shock absorber system of claim 1, wherein:
the system is configured to perform machine learning on real-time sensor data and to compare the real-time sensor data with historical sensor data to identify anomalies and/or outliers and/or to predict industrial shock absorber failure by comparing the real-time sensor data with patterns from historical data and/or models.

16. The industrial shock absorber system of claim 1, wherein:
the system is configured to provide a notification if the system determines that deviations from a predicted outcome have occurred.

17. A method of detecting degradation in an industrial shock absorber that is subject to repeated applications of an external force in an industrial machine, whereby the industrial shock absorber goes through a cycle as a result of each application of the external force, the method comprising:
utilizing sensor data to measure at least one operating parameter that varies during each cycle of an industrial shock absorber;
storing the sensor data for a plurality of cycles to form historical sensor data;
utilizing a computing device to detect changes in the sensor data for a plurality of cycles to form historical sensor data;
utilizing a computing device to detect changes in the sensor data by comparing more recent sensor data measured after the historical sensor data to the historical sensor data, wherein the computing device is configured to utilize predefined failure criteria to determine if detected changes in the sensor data over time indicate that: 1) failure of the industrial shock absorber has occurred, or 2) failure of the industrial shock absorber is likely to occur within a specified number of additional cycles.

18. The method of claim 17, wherein:
the computing device is configured to find and/or recognize patterns in the historical sensor data and/or the more recent sensor data, wherein the recognized patterns indicate that a failure of the shock absorber has occurred and/or is likely to occur within a predefined number of cycles.

19. The method of claim 18, wherein:
the operating parameter comprises at least one of force, pressure of fluid in the industrial shock absorber, and a Time-Through-Stroke (TTS) of the industrial shock absorber.

20. The method of claim 19, wherein:
the TTS is calculated, at least in part, by determining a time interval between 1) a time at which a pressure of a fluid in the industrial shock absorber rises above a first preselected level, and 2) a time at which a pressure of a fluid in the industrial shock absorber drops below a second preselected level, wherein the first and second preselected levels are equal or not equal.
